(19) United States
(12) Patent Application Publication
(10) Pub. No.: US 2009/0164283 A1
(43) Pub. Date: Jun. 25, 2009

(54) System and method for reception time zone presentation of time sensitive scheduling data

(75) Inventor: Robert Bernard Coley, Palo Alto, CA (US)

Correspondence Address: DAVID LEWIS, 1250 AVIATION AVE., SUITE 200B, SAN JOSE, CA, 95110, US

(73) Assignee: Keep In Touch SystemsTM, Inc.

(21) Appl. No.: 12/316,333

(22) Filed: Dec. 10, 2008

Related U.S. Application Data
(60) Provisional application No. 61/016,010, filed on Dec. 21, 2007.

(51) Int. Cl. G06Q 10/00

(52) U.S. Cl. 705/7

(57) ABSTRACT

Presenting time frame elements of time sensitive scheduling data to an entity based on a reception time zone related to a passive delivery via a time sensitive scheduling data delivery network is described. A communications network passive delivery of time zone adjusted time sensitive scheduling data is accommodated to an entity. Specific time zone adjusted time sensitive scheduling data from originating organizations, affiliated groups of individuals, and individuals are aggregated into time sensitive scheduling data streams. Then the specific time zone adjusted time sensitive scheduling data streams aggregated from multiple originating organizations, affiliated groups of individuals, and individuals are transmitted via the communications network to the entity. Finally, the time sensitive scheduling data is presented in a manner affording the time zone adjustment based on a reception time zone in which the time sensitive scheduling data is being presented.

### CROSS-REFERENCE TO RELATED APPLICATIONS

This application claims priority benefit of U.S. Provisional Patent Application No. 61/016,010, entitled, “SYSTEM AND METHOD FOR RECEPTION TIME ZONE PRESENTATION OF TIME SENSITIVE SCHEDULING DATA,” by Robert B. Coley, filed Dec. 21, 2007, which is incorporated herein by reference in its entirety.

### BACKGROUND OF THE INVENTION

1. Field of the Invention

The invention relates generally to disseminating and displaying aggregated, globally sourced activity information, internet data publication techniques and targeted communications.

2. Description of the Related Art

Today many entities are faced with working and living in a global society. The need to coordinate activities which originate in foreign time zone is becoming more prevalent. More and more meetings are involving participants who attend from a time zone which is different from that of the coordinator. Travel for business and social reasons has continued to increase giving rise to a new class of problems for many participants. This class of problems relates to having to translate activity schedules into multi-time zones.

The basic problem with current approaches may be that they are grounded in recording and presenting all activities displayed from the perspective of a single recording time zone. Thus, if an activity occurs in another time zone from the home time zone of the user of manual and some automated scheduling or calendaring systems, the user may be forced to mentally adjust the time frame for the activity being recorded to the home time zone of the user. Yet another common problem with many automated scheduling and calendaring systems is that if the user changes the time zone on their receiving and display device, the activity times for all activities stored are adjusted when displayed whether the adjustment is appropriate or not. While the user may be able to manually and mentally account for incorrect adjustments by the way they enter the activity's time related attributes, this approach is not available when the activity's information is being passively delivered and the consumer is not involved in the recording of the activity's information.

With current shared calendar systems, the user can only post one time zone as part of activity entry on the system and therefore is confronted with a dilemma: what start and end time should be used on the calendar for activities which are hosted, attended, coordinated, or participated in a different time zone or multiple time zones. At present, the user may be able to post additional textual information on an appointment entry as a reminder. This is time consuming and does not necessarily avoid the problems associated with missed appointments due to improper or failed time translations.

### SUMMARY OF THE INVENTION

The present disclosure accommodates the presentation of time frame elements of time sensitive scheduling data.

In one embodiment of the invention, presenting time frame elements of time sensitive scheduling data to an entity based on a reception time zone related to a passive delivery via a time sensitive scheduling data delivery network comprises accommodating a communications network passive delivery of time zone adjusted time sensitive scheduling data to an entity, aggregating into time sensitive scheduling data streams, specific time zone adjusted time sensitive scheduling data from originating organizations, affiliated groups of individuals, and individuals, transmitting via the communications network specific time zone adjusted time sensitive scheduling data streams aggregated from multiple originating organizations, affiliated groups of individuals, and individuals to the entity, and presenting time sensitive scheduling data and notices of upcoming time sensitive data activities in a dynamically adjusted manner affording the time zone adjustment based on a reception time zone in which the time sensitive scheduling data is being presented.

Another embodiment of the invention relates to transforming home time frame elements of time sensitive scheduling data in a manner affording time frame identification in the reception time zone in which the time sensitive scheduling data item is being transmitted and presented.

In another embodiment of the invention, transforming consists of exposing time zone indicators, and wherein exposing time zone indicators represents the amount of presentation necessary to communicate when an activity occurs in its home time zone relative to the reception time zone where the activity is being presented.

In another embodiment of the invention, transforming occurs within a programming function at the sourcing data center for transmission and on capable time sensitive scheduling data receiving devices for presentation.

Another embodiment of the invention relates to establishing the reception time zone presentation state (for example, visible or non-visible, played or silenced, animated or non-animated) for transmission and presentation of time sensitive scheduling data according to a base time zone for displaying and playing the time sensitive scheduling data.

Another embodiment of the invention relates to establishing the reception time zone presentation state for transmission and presentation of time sensitive scheduling data according to a designated reception time zone for the time sensitive scheduling data.

Another embodiment of the invention relates to establishing the reception time zone presentation state for transmission and presentation of reminder time sensitive scheduling data according to a receiving entity's reception time zone presentation preference for time sensitive scheduling data, the closeness to start time for the reminder time sensitive scheduling data activity, and a device receiving the reminder time sensitive scheduling data.

In another embodiment of the invention, the reminder time sensitive scheduling data is selected from the group consisting of receiving entity designated reminder items, receiving entity tagged reminder items, time sensitive scheduling data treated as observances, and a combination thereof.

In another embodiment of the invention, establishing the reception time zone presentation state consists of setting the reminder time sensitive scheduling data item's visibility attribute state to show item and representations of the item when presented, and setting the item's play attribute state to play item when presented, whenever the current time in the designated reception time zone falls within the reminder time sensitive scheduling data item's visibility and play activation time frame offset from the starting time of the time sensitive scheduling data on which the reminder time sensitive data item is based.

In another embodiment of the invention, establishing the reception time zone presentation state consists of setting observances time sensitive scheduling data item's visibility attribute state to show item and representations of the item when the current date in the designated reception time zone falls on the same date as the time sensitive scheduling data item being treated as an observance.

Another embodiment of the invention relates to establishing the reception time zone presentation state for transmission and presentation of reservation time sensitive scheduling data according to a receiving entity's presentation reception time zone presentation preference for time sensitive scheduling data, the closeness to start time for the reservation time sensitive scheduling data activity, and a device receiving the reservation time sensitive scheduling data.

In another embodiment of the invention, the reservation time sensitive scheduling data is selected from the group consisting of alerts, reminders, warnings, and time period count downs associated with appointments, pre-arranged blocks of time set aside to receive services for the group of services including transportation reservations, medical appointments, vehicle repair reservations, dinner reservations, and a combination thereof.

In another embodiment of the invention, establishing the reception time zone presentation state consists of setting the reservation time sensitive scheduling data item's visibility attribute state to show item and representations of the item when presented, and setting the item's play attribute state to play item when presented, whenever the current time in the designated reception time zone falls within the reservation item sensitive scheduling data item's visibility and play activation time frame offset and the current time has not passed beyond the starting time of the time sensitive scheduling data on which the reservation time sensitive data item is based.

In another embodiment of the invention, the time frame adjustment afforded is based on the representation of a time sensitive scheduling data item within a communication transmitted from the data center source data store to the receiving device.

In another embodiment of the invention, presenting time sensitive scheduling data consists of receiving, transforming, displaying and playing time sensitive scheduling data. In another embodiment of the invention, the representation of the time zone indicators of a time sensitive scheduling data item range from presenting no indicator to presenting a home time zone start time, a home time zone end time, a home time zone indicator, a home time zone of the time sensitive scheduling data item, reception time zone start time, reception time zone end time, reception time zone indicator, reference time zone start time, reference time zone end time, and reference time zone indicator.

Another embodiment of the invention relates to adjusting reception time zone presentation to a time sensitive scheduling data delivery network user by presenting the time sensitive scheduling data item's time frame in accordance with the time sensitive scheduling data receiving device's profile and assigned preference.

In another embodiment of the invention, the time sensitive scheduling data receiving device's preference is assigned based on device capabilities. Some receiving devices may be capable of identifying and passing the physical reception time zone and the current time parameters within that time zone to the Reception Time Zone Presentation Method processes. Other receiving devices may remain fixed on the home time zone of the receiving device unless manually adjusted. When the receiving device is capable of dynamically providing the reception time zone, the receiving device's preference may be set for automatically assisting in the dynamic adjusting of the presentation of the time elements of the current time display, and the activity, reminder and reservation time sensitive scheduling data items.

In another embodiment of the invention, the time sensitive scheduling data receiving device's preference is assigned based on receiving entity preferences for the receiving device.

In another embodiment, a system for presenting time frame elements of time sensitive scheduling data to an entity based on a reception time zone related to a passive delivery via a time sensitive scheduling data delivery network is described. The system may include a time sensitive scheduling data center for storing time frame elements of time sensitive scheduling data, collecting time frame elements of time sensitive scheduling data from a providing entity, and sending time frame elements of time sensitive scheduling data to a consuming entity, connectivity medium communication interfaces for transmitting time frame elements of time sensitive scheduling data between the time sensitive scheduling data center, a communication technology, and a time sensitive scheduling data receiving device, and a communication technology suitable for receiving and sending the passive delivery of time frame elements of time sensitive scheduling data. The system may also include processors for processing executable instructions for accommodating a communications network passive delivery of time zone adjusted time sensitive scheduling data to an entity, aggregating into time sensitive scheduling data streams, specific time zone adjusted time sensitive scheduling data from originating organizations, affiliated groups of individuals, and individuals, transmitting via the communications network specific time zone adjusted time sensitive scheduling data streams aggregated from multiple originating organizations, affiliated groups of individuals, and individuals to the entity, and presenting time sensitive scheduling data and notices of upcoming time sensitive data activities in a dynamically adjusted manner affording the time zone adjustment based on a reception time zone in which the time sensitive scheduling data is being presented. Finally, the system may also include a time sensitive scheduling data receiving device for receiving and sending time frame elements of time sensitive scheduling data to the time sensitive scheduling data center via the connectivity medium communication interfaces via the communication technology.

Another embodiment provides a computer program product executable by a computer processor for processing the presenting of time frame elements of passive delivery time sensitive scheduling data to an entity based on a reception time zone via a time sensitive scheduling data delivery network. The computer program product includes computer code for accommodating a communications network passive delivery of time zone adjusted time sensitive scheduling data to an entity, computer code for aggregating into time sensitive scheduling data streams, specific time zone adjusted time sensitive scheduling data from originating organizations, affiliated groups of individuals, and individuals, computer code for transmitting via the communications network specific time zone adjusted time sensitive scheduling data streams aggregated from multiple originating organizations, affiliated groups of individuals, and individuals to the entity, computer code for presenting time sensitive scheduling data and notices of upcoming time sensitive data activities in a dynamically adjusted manner affording the time zone adjustment based on reception time zone in which the time sensitive scheduling data is being presented, and computer readable medium for storing the computer code.

### BRIEF DESCRIPTION OF THE DRAWINGS

Detailed and specific features of the present invention are more fully disclosed in the following sections, with reference being made to the accompanying drawings, in which:

FIG. 1 is a simplified system diagram of a time sensitive scheduling data delivery network according to one embodiment of the invention;

FIG. 2 is a representation of a time sensitive scheduling data delivery network and shows the location of a reception time zone presentation of time sensitive scheduling data functions according to one embodiment of the invention;

FIG. 3A is a flowchart of a time sensitive scheduling data fulfillment process showing the locations of the reception time zone presentation of time sensitive scheduling data functions, and is a representation of the Time Sensitive Scheduling Data Reception Time Zone Presentation of Time Sensitive Scheduling Data Method according to one embodiment of the invention;

FIG. 3B is a flowchart of the time sensitive scheduling data fulfillment process showing the basic components involved in a Reception Time Zone Presentation method according to one embodiment of the invention;

FIG. 4A is a class diagram displaying Time Sensitive Scheduling Data Time Zone classes;

FIG. 4B is a sample screen display of a Time Zone Display Controls maintenance screen;

FIGS. 4C1, 4C2, and 4C3 are graphical representations of Time Sensitive Scheduling Data Reception Time Zone Elements according to one embodiment of the invention;

FIGS. 5A and 5C provide schematics of time sensitive scheduling data receiving device display pages;

FIG. 5B and FIGS. 5D-5G show examples of how individual time sensitive scheduling data items may appear;

FIG. 6 shows a flowchart of two Time Sensitive Scheduling Data Time Zone specification methods which a user may use to specify a desired time zone presentation for displayed TSSD according to one embodiment of the invention;

FIG. 7 is a class diagram illustrating time sensitive scheduling data providers of time sensitive scheduling data according to an embodiment of the invention;

FIG. 8 shows primary activity functions of a time sensitive scheduling data fulfillment process according to one embodiment of the invention;

FIG. 9 is an objects diagram illustrating basic attributes for time sensitive scheduling data according to an embodiment of the invention;

FIG. 10 is a class diagram illustrating classes of time sensitive scheduling data Activity Sources according to an embodiment of the invention; and

FIG. 11 is a class diagram illustrating target audiences for time sensitive scheduling data according to one embodiment of the invention.

### DETAILED DESCRIPTION OF THE INVENTION

Reference throughout this specification to “one embodiment” or “an embodiment” means that a particular feature, structure, or characteristic described in connection with the embodiment may be included in at least one embodiment of the present invention. Thus, the appearance of the phrase “in one embodiment” or “an embodiment” in various places throughout this specification does not necessarily refer to the same embodiment. Furthermore, the particular features, structures, or characteristics may be combined in one or more embodiments.

In the following description, for purposes of explanation, numerous details are set forth, such as flow charts and system configurations, in order to provide an understanding of one of more embodiments of the present invention. However, it is and will be apparent to one skilled in the art that these specific details are not required in order to practice the invention.

Accordingly, what is needed is a more flexible and efficient approach in which activity information can be recorded anywhere globally, delivered passively and displayed anywhere relative to a time zone which is relevant to the user's task or goal. In addition, the display system should be flexible enough to provide such addition time zone references as necessary to assist the user in recognizing “foreign activities;” activities which take place in foreign time zones.

In one embodiment of the systems and methods disclosed herein, the components may be a type of activity data referred to as time sensitive scheduling data (TSSD) described herein, a set of functions which encompass the collection, storage, maintenance and orderly dissemination of TSSD, a set of functions which apply reception time zone presentation methods to the TSSD, hardware and software which perform these functions and entities which produce and consume TSSD.

### Definitions

As used in this description and the accompanying claims, the following terms shall have the meanings indicated, unless the context otherwise requires:

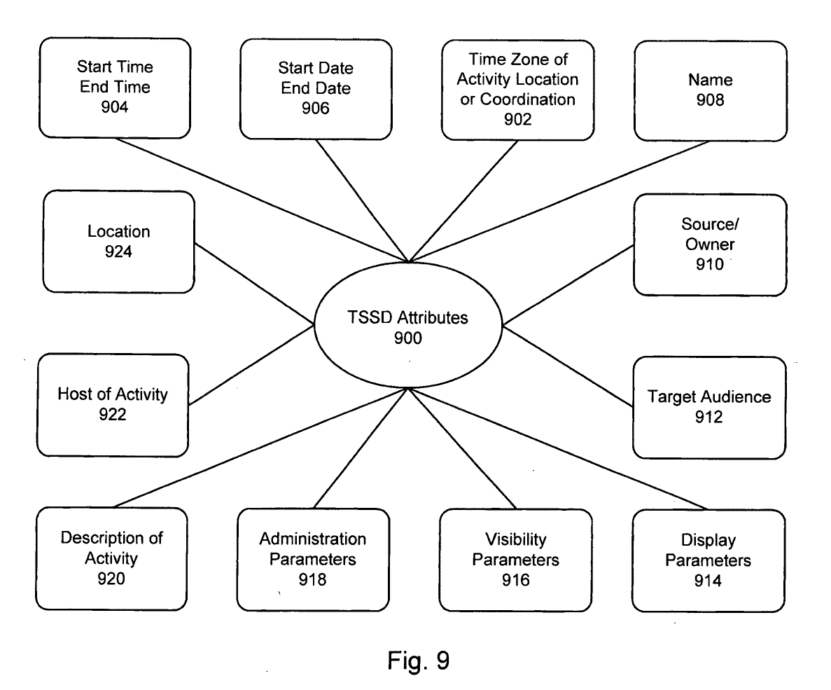

“Time sensitive scheduling data (TSSD)” refers to data relating to the class of entity activities including attending, timely participating, scheduling, planning, organizing, responding and reserving. The TSSD originates from the class of TSSD activity sources including standard events, standard meetings, ad hoc activities, and observances. This TSSD data has high utility and is frequently referenced in its relationship to an individual's continually changing activities. Also such data is not of transitory interest to users, since checking one's schedule is a necessary activity that an individual does numerous times on a daily basis. An objects diagram in FIG. 9 illustrates the basic attributes for TSSD.

“Channel” may refer to a data stream containing one or more “profiled” (selected based on specific criteria which may include affiliation, interests, time frame, geographic basis of source and type of TSSD) and prioritized feed packets of content.

“Cloud” may refer to homogeneous groups of cooperating networks which deliver data from a source to a destination via one or more paths that may be determined by the cooperating networks components and not the originating source device or the destination receiving device. It should be appreciated that the path by which the data reaches the source may be unpredictable or unidentifiable in advance.

“Entity” may refer to consuming entities whose actions consume time sensitive scheduling data, producing entities whose activities produce time sensitive scheduling data, providing entities who submit time sensitive scheduling data intended for consumption by other entities, and receiving entities who control what is received and presented on the time sensitive scheduling data receiving device used for consumption of time sensitive scheduling data by entities. The consuming entities may include individual members or affiliates of time sensitive scheduling data delivery network client organizations, interested individuals who browse time sensitive scheduling data network communications site, time sensitive scheduling data delivery network subscribers, members or affiliates of entities displaying time sensitive scheduling data activity feeds, and individuals passing by areas display time sensitive scheduling data activity feeds. The producing entities may include individuals, members of formal organizations, staffs of formal organizations, affiliated groups of individuals, viewers from non-affiliated groups, individuals in common interest groups, and individuals in a common space at the same time. Both the providing entities and receiving entities may include individuals, members of formal organizations, staffs of formal organizations, members of affiliated groups of individuals in non-formal organizations, and individuals in common interest groups.

“Connectivity medium” means a medium (e.g., air, wire, or fiber) between two or more nodes that provides a communication network with a channel. In the present disclosure, the connectivity medium may function as a channel that communicates the required request, credentials, and keys that allow for the movement of TSSD.

“Distribute TSSD” may refer to the streaming of TSSD data to TSSD receiving devices when a specific profile match or a specific affiliation match is present or the receiving entity is known to the TSSD provider.

“Disseminate TSSD” may refer to the streaming of TSSD data to TSSD receiving devices when a specific profile match or a specific affiliation match may not be present or the receiving entity is unknown to the TSSD provider.

“Feed” may refer to a data stream containing one or more specific categories of content. Individual units of content may be designated as feed packets or payloads. Each feed may comprise a set of rules for pulling TSSD out of the data store.

“Need to Know data” may refer to data pertaining to activities or events which impact the health and safety of an individual, a community's members, an individual's relations or a specific group of individuals. Need to know time sensitive scheduling data may include activities which are generally non-routine, unscheduled or unplanned activities. Need to know time sensitive scheduling data may include data such as the occurrence of a natural disaster and its related recovery activities: opening of shelters, delivery schedule of food, water and supplies, and opening of relief services offices. Other examples may include road opening and closing schedules, school or public service office opening and closing schedules.

“Network” may refer to groups of computers, terminals, phones, cameras, and linking communications devices which may include routers, switches, hubs, antennas, and relays linked by wired or wire-less telecommunications systems for the purpose of exchanging data. Network, as used herein, may generally refer to a group of devices working together for a specific purpose involving the exchange of data.

“Server” may refer to any combination of computer hardware or dedicated computing device(s) and software which has as one of its functions the collection, storing, aggregation, packaging and/or dissemination of a specific class of data upon request. In one embodiment, a combination which comprises a server may be based on the homogenous data or data formats that are extracted from storage, manipulated if necessary by some set of rules or policies, and “served up” upon request from one or more entities or functions which consume the data to perform its processes. A single computer may host (provide) several server functions and a single server function may be hosted (shared/provided) by more than one computer or dedicated computing device.

An “activity acquisition” server may refer to a server which functions to harvest, aggregate and/or manipulate TSSD activity data.

An “organization-managed” activity acquisition server may refer to an activity acquisition server where the activity data harvested by such server may have been created and maintained on the server by any or all members of the organization providing the activity data and the organization take responsibility for the content of the activity data (e.g., activity name, description, activity date, activity time, activity location, attendee policy and fees).

An “individual-managed” activity acquisition server may refer to an activity acquisition server where the activity data harvested by such a server is at least one of the activities of others, i.e., not originated by the individual, but recorded and maintained on the server by the individual providing the activity data and is the personal activities of individual, wherein the individual takes responsibility for the content of the activity data (e.g., activity name, description, activity date, activity time, activity location, attendee policy and fees).

A “foreign activity acquisition server” may refer to an activity acquisition server where the activity data harvested by such server is the activities not of the providing organization, but of others, i.e., not originated by the organization providing the data. The activity data may be recorded, but not maintained on the server by the organization providing the activity data.

“Site” means a reception zone for the receipt of TSSD that is cross-platform and cross-technology (e.g. web, handheld mobile devices, TV, kiosks, cellular phones, and other similar devices).

“Time Zone” may refer to one of the time zones of the Coordinated Universal Time (UTC) systems geographically designated time zones with allowances for geo-political adjustments where governments have not strictly adhered to the latitudinal coordinates for the UTC time zones or have adjusted boundaries to accommodate regional governance issues. As used herein, a time zone may be a region of Earth that has accepted the same standard time, i.e., a locally accepted clock offset from the UTC.

“Base Time Zone” may refer to the time zone used to determine part of the formatting for individual TSSD items displayed; it is the basic reference point in a TSSD display. It may affect the placement of a TSSD item on a time frame scale and may affect the appearance of additional time zone indicators connective with a given TSSD item.

“Foreign Time Zone” may refer to the activity time zone of TSSD items which occur in a different time zone from the Base Time Zone. The TSSD activity may be referred to as a “foreign activity.”

“Time Frame Elements” may include an activity's start and end time, start and end date, and the local time zone where the activity will occur, be hosted or be the designated center of coordination.

A “Home TSSD Item” may refer to a TSSD item whose home activity time zone is the same as the base time zone.

A “Foreign TSSD Item” may refer a TSSD item whose home activity time zone differs from the base time zone.

“Transmit” means to transfer data from one device to another device via one or more communications protocols, one or more communications media and one or more communication applications which facilitate the transfer of data across communications media by implementing one or more communications protocols. In an embodiment of the invention, TSSD and related collateral data can be transmitted via email, http protocol to a host browser over the Internet, via cellular or other telephony text messaging systems, via voice over a telephony network, over broadcast systems for radio, TV, cable and satellite and over evolving systems for extending the internet: Wi-Fi networks, public utility electrical systems, fiber optic communications systems, microwave communications, photoelectric communication system and wired local area networks.

In one embodiment of the invention, the display or play adjustments afforded to a time sensitive scheduling data item may be based on the location of the time sensitive scheduling data receiving device display (reception time zone), the home time zone of the receiving entity (entity home time zone), or another receiving entity designated reception time zone (aka, a reference time zone). The display enhancement may include showing local start and end time, the item's home time zone start and end time plus time zone indicator, and the item's start and end times in the entity's home time zone plus time zone indicator. The time frame view display enhancement may include displaying both an entity's home time frame scale and a base time frame scale which may be either a reflection of the reception (local) time zone or a designated foreign time zone.

Another embodiment of the invention relates to protecting the integrity of each time sensitive scheduling data item for the many diverse users of the time sensitive scheduling data delivery network relates to not destroying the source time frame data for a time sensitive scheduling data item.

Another embodiment of the invention relates to displaying time sensitive scheduling data in a manner which conveys the essence of an activity sufficient for the user to make scheduling decisions which may include making decisions about attendance and participation in an activity, becoming informed of upcoming activities and observances, and providing a time sensitive scheduling data delivery network user a designated and desired level of time frame informational content for the time sensitive scheduling data displayed.

In another embodiment of the invention, the user may designate a manner for the display or transmission of the user's requested time sensitive scheduling data which allows the user to dynamically control how much content representing the time frame of the time sensitive scheduling data appears.

In another embodiment of the invention, the time sensitive scheduling data network may simultaneously support different manners of transmission or display of time frame content for the same activity being displayed on different time sensitive scheduling data receiving devices.

In another embodiment of the invention, relevant and desired time sensitive scheduling data may be delivered in a geographically localized reception time zone display mode to the entity wherever the entity may be.

In another embodiment of the invention, communications network delivery of reception time zone adjusted time sensitive scheduling data to an entity may include sending and receiving, via a communications network, specific time sensitive scheduling data from originating organizations, affiliated groups of individuals, and individual sources, transmitting via the communications network specific time sensitive scheduling data streams aggregated from multiple originating organizations, affiliated groups of individuals, and individual sources to the entity based on desirability and relevancy of high utility time sensitive scheduling data, and accommodating the delivery of reception time zone adjusted time sensitive scheduling data to the entity via a time sensitive scheduling data receiving method based upon interests of the entity.

In another embodiment of the invention, the specific reception time zone adjusted time sensitive scheduling data sent and received may be related to activities of at least one of originating organizations, affiliated groups of individuals, and individual sources.

In another embodiment of the invention, the specific reception time zone adjusted time sensitive scheduling data may be transmitted as an individual item and in bulk.

In another embodiment of the invention, accommodating the delivery of reception time zone adjusted time sensitive scheduling data may include establishing the reception time zone display mode for transmission or display of reminder time sensitive scheduling data according to an entity's display mode preference for time sensitive scheduling data, the closeness to start time for the time sensitive scheduling data activity which is the subject of the reminder, or the device receiving the time sensitive scheduling data activity which is the subject of the reminder.

In another embodiment of the invention, accommodating the delivery of reception time zone adjusted time sensitive scheduling data may include establishing the reception time zone display mode for transmission or display of reservation time sensitive scheduling data according to an entity's display mode preference for time sensitive scheduling data, the closeness to start time for the reservation, or the device receiving the reservation time sensitive scheduling data.

In another embodiment of the invention, accommodating the delivery of reception time zone adjusted time sensitive scheduling data may include establishing the reception time zone display mode for transmission or display according to an entity's need to know.

In another embodiment of the invention, accommodating the delivery of reception time zone adjusted time sensitive scheduling data may include establishing the reception time zone display mode for transmission or display according to an entity's affinities.

In another embodiment of the invention, the time sensitive scheduling data as described above consists of data relating to the class of entity activities selected from the group consisting of attending, timely participating, scheduling, planning, organizing, timely responding, reserving, and a combination thereof. The class of entity activities originates from the class of time sensitive scheduling data activity sources selected from the group consisting of standard events, standard meetings, ad hoc activities, observances, and a combination thereof.

In another embodiment of the invention, the passive delivery of the time sensitive scheduling data to the entity as described above may include the entity not having identified in advance the specific time sensitive scheduling data items delivered, not having requested the specific time sensitive scheduling data items which are transmitted based on a receiving device and consumer profile, and not having any content control of the specific time sensitive scheduling data items which have been delivered in advance of the time sensitive scheduling data items presentation.

In another embodiment of the invention, the passive delivery of the time sensitive scheduling data to the entity as described above may include the entity yielding control over the specific time sensitive scheduling data items selected for delivery, yielding control over the volume of time sensitive scheduling data items delivered, yielding control over how much information is delivered about the specific time sensitive scheduling data items, and yielding control over delivery time.

In another embodiment of the invention, the passive delivery of the time sensitive scheduling data to the entity as described above may include time sensitive scheduling data items selected for delivery based on the entity's derived interest and need to know related to the public health and safety of the entity and entity's current condition and state being impacted by the public health and safety issue.

In another embodiment of the invention, the time sensitive scheduling data items delivered as described above are selected from the group consisting of being known to a consuming entity in advance of their presentation, being unknown to a consuming entity in advance of their presentation, being not provided by the consuming entity, being targeted directly or indirectly at the consuming entity as a member of a class possessing specific attributes by the providing entities, belonging to a time sensitive scheduling data channel which has been subscribed to by the consuming entity, belonging to a time sensitive scheduling data channel which has been assigned to the consuming entity, pertaining to the time frame being presented by the time sensitive scheduling data receiving device, and a combination thereof.

Another embodiment of the invention relates to extracting time sensitive scheduling data from time sensitive scheduling data delivery network data center stores based on fulfillment requests consisting of fulfillment request from the group including time sensitive scheduling data provider targeting requests, requests derived from subscriber profiles, requests derived from time sensitive scheduling data receiving device's profile, requests based on the consumer user's affiliations and affinities, and specific requests from an entity using a time sensitive scheduling data receiving device.

In another embodiment of the invention, transmitting consists of delivering items from a central data store to a time sensitive scheduling data receiving device via a communications network by performing the necessary media and medium transformations and connections necessary to affect the delivery.

Another embodiment of the invention relates to transmitting the specific time zone adjusted time sensitive scheduling data as an individual item and in aggregated data streams.

Another embodiment of the invention relates to transmitting time sensitive scheduling data via the communications network in a manner which conveys the essence of an activity and its time frame sufficient for the entity to become informed of upcoming observances and activities and to make decisions from tasks selected from the group consisting of planning, scheduling, attending, opening, closing, rendezvousing, acknowledging, and observing.

Another embodiment of the invention relates to transmitting time sensitive scheduling data via the communications network in a manner which conforms to the entity's desired reception time zone presentation preferences based on tasks selected from the group consisting of planning, scheduling, attending, opening, closing, rendezvousing, acknowledging, and observing.

Another embodiment of the invention relates to presenting time sensitive scheduling data in a dynamically adjusted manner which conveys the essence of an activity and its time frame sufficient for the entity to become informed of upcoming observances and activities and to make decisions from tasks selected from the group consisting of planning, scheduling, attending, opening, closing, rendezvousing, acknowledging, and observing.

Another embodiment of the invention relates to adjusting reception time zone presentation to a time sensitive scheduling data delivery network user by presenting the time sensitive scheduling data items' time frame in accordance with the user's designated reception time zone presentation preference.

Another embodiment of the invention relates to presenting time sensitive scheduling data in a manner which expresses the entity's desired reception time zone presentation preference related to time sensitive scheduling data source types from the group consisting of standard events, standard meetings, ad hoc activities, and observances.

Another embodiment of the invention relates to presenting time sensitive scheduling data in a manner which expresses the entity's desired reception time zone presentation preference related to tasks selected from the group consisting of planning, scheduling, attending, opening, closing, rendezvousing, acknowledging, and observing.

The TSSD reception time zone presentation method described herein may include portable display TSSD receiving devices selected from the group comprising mobile computing devices, personal digital assistants (PDAs), cellular phones, personal computers, portable workstations, and a combination thereof.

The TSSD reception time zone presentation method may include fixed placement display TSSD receiving devices in display locations selected from the group comprising public place business display screens, home entertainment appliance display screens, business display screens in a public place, business display screens on company property in public areas, business display screens on company property in private areas, and a combination thereof.

The TSSD reception time zone presentation method may include linked devices in the fixed placement display TSSD receiving device selected from the group comprising computers that run a single function TSSD delivery network access software product, computers that run browsers linked into a TSSD display website, computers that run a TSSD tuner and display software, set top tuners for home entertainment appliances, and stand alone tuners with web access, and a combination thereof.

The present invention can be implemented in various different forms, including but not limited to: business processes, computer implemented methods, computer program products, computer systems, and communication networks, user interfaces, application programming interfaces, and the like.

The communications network may include simple devices, advanced devices, individual access devices, and community access devices.

The simple device may be a low-end price competitive device that receives TSSD. It may be able to send a Yes/No indicator in response to something on the device screen. The simple device may also receive TSSD based on who the user is and/or what the interest profile is of the user.

The aforementioned advanced device may have all the capabilities of the simple device plus some additional communications capabilities. For example, the advanced device may have a full two-way interactive device. The advanced device may include a larger screen and easy manipulation of on-screen information. The advanced device may come in various sizes and shapes and changes where people may go to get critical information at several points during their day. The embedded systems devices may include cellular phones, PDAs, mobile digital assistants with cellular phones, text messaging devices and PDAs and Java (MIDP-mobile information device profile) enabled devices, multifunction wristwatches, and handheld computing devices.

The individual access devices such as a laptop computer, desk top computer, cellular phone, and/or PDA may allow a single user to receive TSSD into a reception zone, often in a web browser format. These individual access devices typically already have web browser capability built-in. One of the access devices in this category may be a web browser with a special web interface that is designed to receive TSSD. This mimics the advanced device functions somewhat, except as a web application. Another access device may be a cellular phone using the web interface that is now available in many mid-to-high end cellular phones. Also another access device may be a PDA using the internet interface that is available now in cellular or Wi-Fi connected PDA devices. It may be appreciated that other embedded system devices can use non-web integration and/or non-internet integration using alternative communication technologies.

The community access devices may allow multiple users to receive TSSD into a reception zone, often in a web browser type format. One of the access devices in this category may be a set top box, for example. The set top box may use the web interface and keyboards that are available with some set top box vendors, which may provide in-home TV access to TSSD. Another reception zone is a kiosk, which may provide typically activity data shown in a communal or public area. Vertical kiosk applications come out of this area with payment structures such as from a sponsor paying to the public user paying. In some parts of the world, this is a substitute for a local or regional newspaper or a way to check on government services without a long wait in lines. A third community reception zone is a broadcast channel which may allow the user to receive TSSD into a reception zone on a broadcast media channel the user is watching. These are zones of traveling message data strips on cable channels or more standalone captive areas like airport system screens. The scrolling TSSD seen there is based on location and the business function at that location. The media types for these streams are varied and include internet protocol, telephony, and both on-air cable and private cable.

In a pure push system, content may be streamed to a user as determined by the provider. The user may have the option of consuming (i.e., viewing, listening, or feeling) the content or ignoring the content. In one modified push system, the user may have the option to block (filter) unwanted content and the provider can not override the consumer's choice not to receive specific types of content.

In a pure pull system, a user can request specific available content and the content may be streamed to the user's receiving device for consuming (i.e., viewing, listening, or feeling). In one modified pull system the user may request a category of content or specific content, but the provider has the option to target specific consumers and thereby filter what is streamed to a user. In that fashion, the user cannot override the provider's choice not to stream content to the specific user.

In the TSSD reception time zone presentation method, the types of data collected from providers may include meeting information, event information, and volunteer opportunity information. Based on this type of collected data, the TSSD reception time zone presentation can be implemented in a manner which shields activity details from viewers or listeners according to the wishes of the originator, owner, system administrator or user requesting the activity data.

In one embodiment, private TSSD may be activity content provided by the ultimate consumer of the TSSD for that consumer's private use. There may not be an intent for this information to be shared with other entities with the possible exception of family members, i.e., pushed on TSSD channels. When a user is streamed their private TSSD, no filtering may need to be applied.

In another embodiment, public TSSD may be activity content provided with the intent of this content being consumed (i.e., viewed, heard, or felt) by affiliated or subscribed entities. The intent may be to inform others by providing this content for distribution to affiliated entities.

In another embodiment, a privacy circle may be a set of one or more entities designated by a private TSSD provider to be treated as a proxy or the same as the entity providing the private TSSD content. Thus, entities of a privacy circle may inherit the same attributes and a status as the TSSD provider with regards to the specific channel in which that private TSSD is streaming.

According to another embodiment, the TSSD fulfillment process may involve both a modified push system in which content is sent to the user, and a modified pull system in which the user requests the content details or opens a gateway to new TSSD content. At any given moment a user may be receiving pushed content from one or more channels streams based on the list of channels which the user has authorized, i.e., chosen to monitor. In addition, the same user may be receiving pushed content which is sponsoring the chosen channel or content which is targeted at the channel.

In the TSSD fulfillment process, the type of data collected from providers and streamed to consumers may be public or private. In the modified push system, the public TSSD content may come filtered by at least one of a TSSD profile category, region purchased and jurisdiction purchased. The private data may be streamed unfiltered, but targeted only to the user or their designated privacy circle. In the modified pull system, the requested private TSSD content detail may be returned to its user or their designated privacy circle, but may be blocked from streaming to any other requesting entity. In the modified pull system the requested public TSSD content detail may be returned if the requestor's profile or affiliation meets the targeting criteria of the public TSSD content provider.

In a global passive time sensitive scheduling data delivery system as present in an embodiment of the TSSD Delivery Network Reception Time Zone Method, efficiency and value may be derived from recording TSSD activities only once and making that information available to any subscriber, in a manner which the receiver can properly interpret the time frame for the occurrence of the activity or observance.

According to one embodiment of the TSSD fulfillment process, streaming filtered, reception time zone adjusted TSSD that fall into a specific category of TSSD and area of interest of the entity may be transmitted.

In another embodiment of the TSSD fulfillment process, the targeted delivery of reception time zone adjusted TSSD may be to a display device at a location where viewers matching a specific profile are trafficking.

In another embodiment of the TSSD fulfillment process, the delivery of reception time zone adjusted TSSD may be to a communications display in response to an occurrence of a specific event.

In another embodiment of the TSSD fulfillment process, the delivery of reception time zone adjusted TSSD may be to an audio device in response to an occurrence of a specific event.

In another embodiment of the TSSD fulfillment process, the delivery of reception time zone adjusted TSSD may include establishing the reception time zone display preference for transmission or display of TSSD according to the area of interest of the entity.

In another embodiment of the TSSD fulfillment process, the delivery of reception time zone adjusted TSSD may include establishing the reception time zone display preference for transmission or display of TSSD according to affiliation between entities.

In another embodiment of the TSSD fulfillment process, communications network based delivery of reception time zone adjusted TSSD to an entity further may include distributing and disseminating TSSD which automatically provides targeted entities with TSSD of personal interest to facilitate timely attendance and participation in a designated area of interest of the entity.

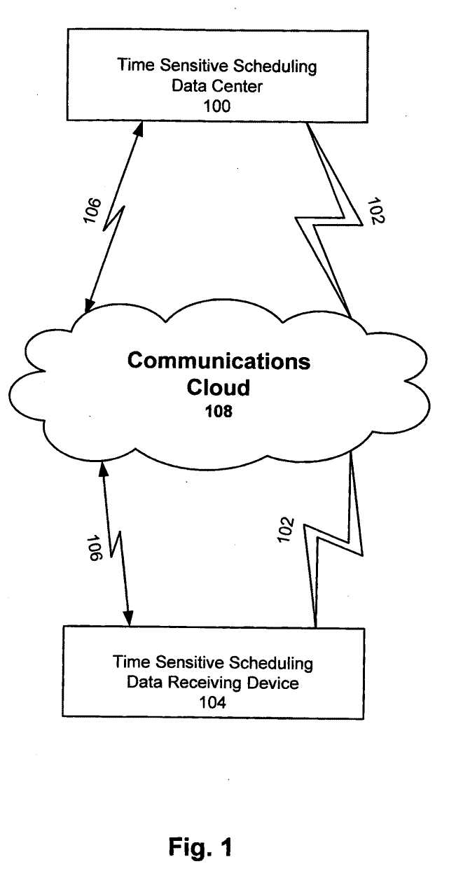

FIG. 1 is a simplified schematic of a TSSD delivery network configured in accordance with the principles of one embodiment of the invention. In the embodiment of FIG. 1, a TSSD center 100 collects and stores TSSD via a connectivity medium 102. A TSSD Receiving Device 104 may then transmit authentication information to the TSSD center 100, via a connectivity medium 106, to a communications cloud 108. The authentication information may contain a subscription fulfillment request, and credentials which include location information (Internet Protocol (IP) address, media access control (MAC) address, mobile identification number (MIN), electronic serial number (ESN), Box ID, subscription channel ID, subscriber ID, or similar ID uniquely identifying the TSSD receiving device 104), and authorization and decoding encryption keys.

The TSSD center 100 may then validate the user's subscription fulfillment request and credentials received from the communications cloud 108 via the connectivity medium 106. If the credentials are valid, the TSSD via the connectivity medium 102 may be returned to the TSSD Receiving Device 104 through the communications cloud 108. If the credentials are invalid, a rejection message may be transmitted to the TSSD Receiving Device 104, via the connectivity medium 106, through the communications cloud 108. The TSSD center 100 streams the TSSD via the connectivity medium 102 related to an organization's, association's, and individual's events, activities, and meetings.

It should be appreciated that the TSSD Receiving Device 104 may include a PDA, cellular phone, or personal computer, or other similar device. The portable TSSD receiving devices may connect to the TSSD center 100 via communications cloud 108, which may include wireless fidelity (Wi-Fi) link, cellular phone service, local access network (LAN), broadband link, or other similar methods, and an Internet service provider's (ISP) services. The method of communication may include an Internet access method and web browser, or a cellular data transfer method.

The TSSD Receiving Device 104 may further include fixed placement display devices. The fixed placement display TSSD receiving devices may provide display locations which may include public place display screens, home entertainment appliance display screens, business display screens in a public place, business display screens on company property in public areas such as a lobby, or business display screens on company property in private areas such as an office or factory floor. The fixed placement display TSSD receiving devices may contain computer access devices and similar devices (software and hardware) which display user functions available to the viewer, carry out communications functions, transmit and receive requests for authorization and TSSD and display messages or results of the requests. The computer access devices in the fixed placement display TSSD receiving devices may include computers that run the single function access software, computers that run browsers linked into a TSSD display website, computers that run a TSSD tuner and display software, set top tuners for home entertainment appliances, stand alone tuners with web access, or other similar devices. The fixed placement display TSSD receiving devices may link to the TSSD center 100 via communications cloud 108 which may include Wi-Fi link, cellular phone service, phone dial-up, radio frequency (RF), LAN, broadband link, satellite, or similar methods. The method of communication may include an Internet access method and web browser, a broadcast data transfer method, a cable media data transfer method or a cellular data transfer method.

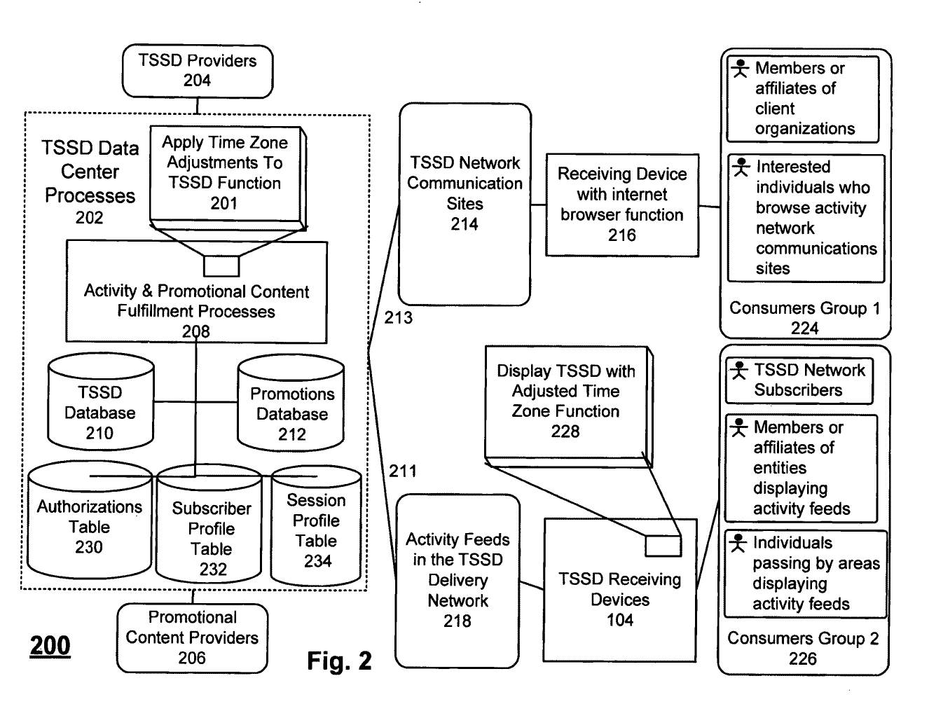

FIG. 2 is a representation of one embodiment of an activity and promotional content delivery communications system 200 showing the location of the Reception Time Zone Presentation Functions in a TSSD delivery network. In this embodiment, activity content from TSSD Providers 204 may be maintained in the TSSD Database 210 and promotional content from Promotional Content Providers 206 may be maintained in the Promotions Database 212 by TSSD Data Center Processes 202. Data to support subscriber access and session management using the delivery network may be maintained in the Authorizations Table 230, Subscriber Profile Table 232, and the Session Profile Table 234. When users in Consumers Group 1 224 and Consumers Group 2 226 initiate sessions via receiving devices, which may include Receiving Devices with internet browser functions 216 and TSSD Receiving Devices 104, the Activity & Promotion Content Fulfillment Processes 208 may extract and transmit on line 213 activity and promotional content which will appear on TSSD Network Communications Sites 214 and on line 211 embedded in Activity Feeds in the TSSD Delivery Network 218. In this embodiment of the invention, TSSD may be targeted at Consumers Group 1 224: members or affiliates of client organizations and interested individuals who because of their affiliation browse the activity network communications sites such as the TSSD Network Communication Sites 214. Reception time zone adjusted TSSD may arrive and may be displayed on Receiving Devices with internet browsers functions 216 based on the Activity and Promotion Content Fulfillment Processes 208 having applied a function to Apply Time Zone Adjustment to TSSD Function 201 before transmission on line 213. TSSD may be targeted at Consumers Group 2 226: TSSD network subscribers, members or affiliates of entities displaying activity feeds and individuals who pass by or through an area displaying activity feeds who because of their affiliation, affinity or interest view the activity content on TSSD Receiving Devices 104. TSSD Receiving Devices 104 may include internet browser enabled and non-internet browser enabled devices. Time adjusted TSSD may arrive and may be displayed on TSSD Receiving Devices 104 with internet browsers functionality based on the Activity and Promotion Content Fulfillment Processes 208 having an Apply Time Zone Adjustments to TSSD Function 201 before transmission on line 211. On non-internet browser enabled TSSD Receiving Devices 104, TSSD content may arrive unadjusted and be converted to time adjusted TSSD prior to displaying the content by an embedded Display TSSD with Adjusted Time Zone Function 228.

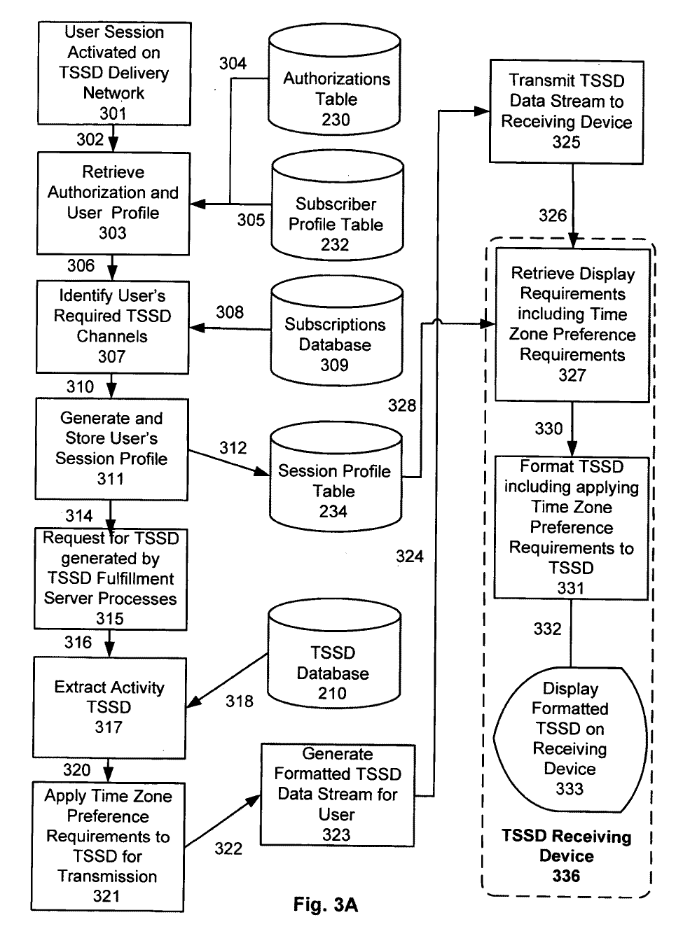

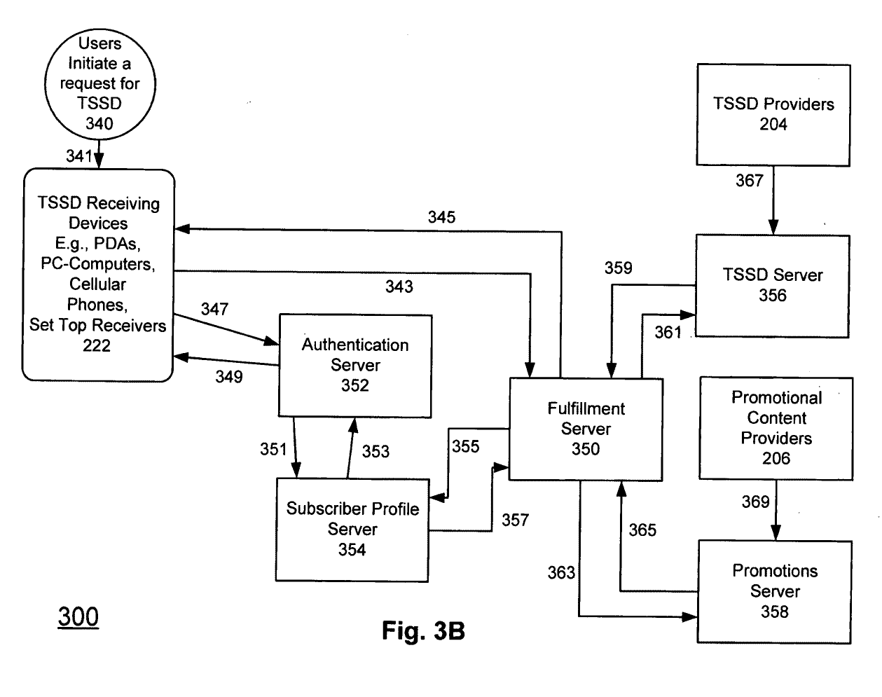

FIG. 3A is a flowchart of a TSSD activity content fulfillment process showing the locations of the reception time zone presentation functions, according to one embodiment of the invention. The process may begin with a user session being activated on the TSSD Delivery Network at block 301. User identification and receiving device identification and profile may be transmitted on line 302 to a Retrieve Authorization and User Profile Function 303. The Retrieve Authorization and User Profile Function 303 can retrieve the user's authorization profile from the Authorization Table 230 on line 304 and user's subscriber profile from the Subscriber Profile Table 232 on line 305.

The user and receiving device identification data and reception time zone display mode preferences may then be transmitted on line 306 to the Identify User's Required TSSD Channel Function 307. The Identify User's Required TSSD Channels Function 307 may extract the user's TSSD channel subscription identifiers from the Subscriptions Database 309 (which it may receive on line 308) and may transmit on line 310 the user and receiving device identification data, the user's reception time zone display mode preferences and the identifiers for the user's authorized and active TSSD channel subscriptions to the Generate and Store User's Session Profile Function 311. The Generate and Store User's Session Profile Function 311 may store, on line 312, a user session profile which may include the user and receiving device identification data, the user's reception time zone display mode preferences, the user's TSSD channel subscriptions, and administrative parameters such a session profile identifier, starting time, and network use limitations to the Session Profile Table 234.

Once the session profile has been successfully stored, the Generate and Store User's Session Profile Function 311 may trigger a status on line 314 which may cause a request for a TSSD data stream to be generated by the TSSD Fulfillment Server Processes 315. The request generated by these processes may include data range, time frame, selection TSSD category, and user TSSD subscriptions. The Request for TSSD to be Generated by the TSSD Fulfillment Server Processes 315 may transmit a request, on line 316, to the Extract Activity TSSD Function 317 for relevant TSSD to be delivered to the user's receiving device, the user and receiving device identification data, the user's reception time zone display mode preferences, the user's TSSD channel subscriptions, and administrative parameters such a session profile identifier, starting time, and network use limitations, The Extract Activity TSSD Function 317 may extract the targeted TSSD on line 318 from the TSSD Database 210 using path 318 and may transmit on line 320 the TSSD along with the user and receiving device identification data and the user's reception time zone display mode preferences.

The Apply Time Zone Preference Requirements to TSSD for Transmission 321 can receive and reformat the activity TSSD for transmission if required by the user's time zone preferences, which may apply to the type or source of the activity TSSD. The Apply Time Zone Preference Requirements to TSSD for Transmission Function 321 may then transmit the results by path 322 to the Generate Formatted TSSD Data Stream for User Function 323, where all of the extracted and formatted TSSD plus identifications information may be consolidated into a TSSD data stream targeted at the user's receiving device.

Continuing to refer to FIG. 3A, the Generate Formatted TSSD Data Stream for User Function 323 may transmit on line 324 the TSSD data stream to the Transmit TSSD Data Stream to Receiving Device Function 325. The Transmit TSSD Data Stream to Receiving Device Function 325 may transmit the TSSD data stream online 326, which may be through the Communications Cloud, to a set of display processes which may reside on the TSSD Receiving Device 336. The Retrieve Display Requirements including Time Zone Preference Requirements Function 327 may receive the TSSD data stream and if there is activity TSSD, may extract from the Session Profile Table 234 reception time zone display requirements for the activity TSSD using path 328. The Retrieve Display Requirements including Time Zone Preference Requirements Function 327 may transmit on line 330 to the Format TSSD including applying Time Zone Preference Requirements to TSSD Function 331 the TSSD data stream and reception time zone presentation requirements, if any. In one embodiment, the Format TSSD may include applying Time Zone Preference Requirements to TSSD Function 331, parse the TSSD data stream, format each TSSD activity as required, and may transmit the results on line 332 to the Display Formatted TSSD on Receiving Device Function 333. The Display Formatted TSSD on Receiving Device Function 333 may then display the time zone adjusted activity TSSD on the receiving devices display unit for the user's consumption.

In one embodiment, an entity's TSSD display zone preferences for transmission of TSSD or displaying or playing TSSD may be determined by the subscriber's preference and this preference may be preserved in the subscriber's profile. In an embodiment, the TSSD Delivery Network or the TSSD receiving device may automatically apply alternative reception time zone display formatting to accommodate a TSSD receiving device's display characteristics. For example, an entity may have designated a preference to display all TSSD time frame elements, but a small screened TSSD receiving device may remove the TSSD item's reception time zone end time and end date, home time zone start time, end time, start date, end date and time zone indicator from the item when it is displayed. This can occur at the Format TSSD including applying Time Zone Preference Requirements to TSSD Function 331 step if affected by the TSSD Receiving Device 336 or at the Apply Time Zone Preference Requirements to TSSD for Transmission Function 321 step if affected by the TSSD delivery network processes.

FIG. 3B is a flowchart of the time sensitive scheduling data fulfillment process showing the basic components involved in the Reception Time Zone Presentation method according to one embodiment of the invention. When a user (an entity) initiates a request for TSSD 340 via a TSSD Receiving Device 222 on line 343 to the Fulfillment Server 350, that request may be accompanied by specific authorizations to use the TSSD Delivery Network, by a session profile identifier, and by user and device identifiers. The authorizations and identifiers may be obtained by the TSSD Receiving Device 222 by transmitting a request for authorization on line 347 to the Authentication Server 352. The user and/or the TSSD Receiving Device 222 may be authorized to use the TSSD Delivery Network, the Authentication Server 352 may request on line 351, the entity's subscriber profile from the Subscriber Profile Server 354. The Subscriber Profile Server 354 may return the entity's subscriber profile identifier on line 353 to the Authentication Server 352. The Authentication Server 352 may transmit on line 349, the subscriber profile identifier, the entity's TSSD Reception Time Zone Presentation preferences, and administrative parameters such as a session profile identifier, starting time, and network use limitations.

In certain embodiments, when the Fulfillment Server 350 has received all of the required identifiers and authorization to use the TSSD Delivery Network, the Fulfillment Server 350 may initiate a fulfillment process and request the entity's TSSD channel subscriptions identifiers on line 355 from the Subscriber Profile Server 354. The entity's activity subscription channels' identifiers may be returned on line 357 to the Fulfillment Server 350. The Fulfillment processes on the Fulfillment Server 350 1) may create or update the user's session profile, 2) may create specific TSSD fulfillment requests based on the entity's TSSD subscription channels, TSSD Reception Time Zone Presentation preferences, the current time, and the requested time frame, 3) may transmit TSSD fulfillment requests on line 361 to TSSD Server 356, 4) may receive TSSD from the fulfillment requests on line 359, 5) may transmit on line 363 TSSD matching parameters to the Promotions Server 358, 6) may receive promotional content on line 365, 7) may format all requested TSSD and promotional content, and 8) may transmit TSSD data streams on line 345 to the TSSD Receiving Device 222.

In one embodiment, the Fulfillment Server's 350 fulfillment process may provide the mechanism by which TSSD Reception Time Zone Presentation Method is achieved. By applying the requesting entity's Reception Time Zone Presentation preferences as a filter to TSSD resulting from all of the entity's TSSD channel subscriptions prior to transmitting the TSSD data streams to the TSSD Receiving Device 222, the TSSD may be presented in a less confusing manner with all of the accompanying benefits of the more informative presentation.

In another embodiment, the TSSD Receiving Device 222 may receive the requested TSSD on line 345 from the Fulfillment Server 350 and may display the formatted TSSD for the consuming entity(ies). If the entity desires to adjust the TSSD Reception Time Zone Presentation displayed during the user session, the request may be transmitted on line 343 to the Fulfillment Server 350 where a user session profile update processes may make the necessary modifications to the entity's user session profile. If the entity desires to adjust the TSSD flow for future user sessions, the adjustment request may be transmitted on line 347 to the Authentication Server 352 and on line 343 to the Fulfillment Server 350. The Authentication Server 352 authorization process function may update the TSSD Reception Time Zone Presentation preferences in authorization record for the entity.

According to another embodiment, the TSSD Server 356 may receive TSSD from TSSD Providers 204 on line 367. The TSSD Server 356 may manage the receipt, maintenance and storage of TSSD as necessary. The TSSD Server 356 may supply TSSD based on requests received on line 361 from the Fulfillment Server 350 and may supply the requested TSSD on line 359 to the Fulfillment Server 350.

In one embodiment, the Promotions Server 358 receives TSSD from Promotional Content Providers 206 on line 369. The Promotions Server 358 can manage the receipt, maintenance and storage of Promotion Content as necessary. The Promotions Server 358 can supply promotional content based on requests received on line 363 from the Fulfillment Server 350 and can supply the requested TSSD on line 365 to the Fulfillment Server 350.

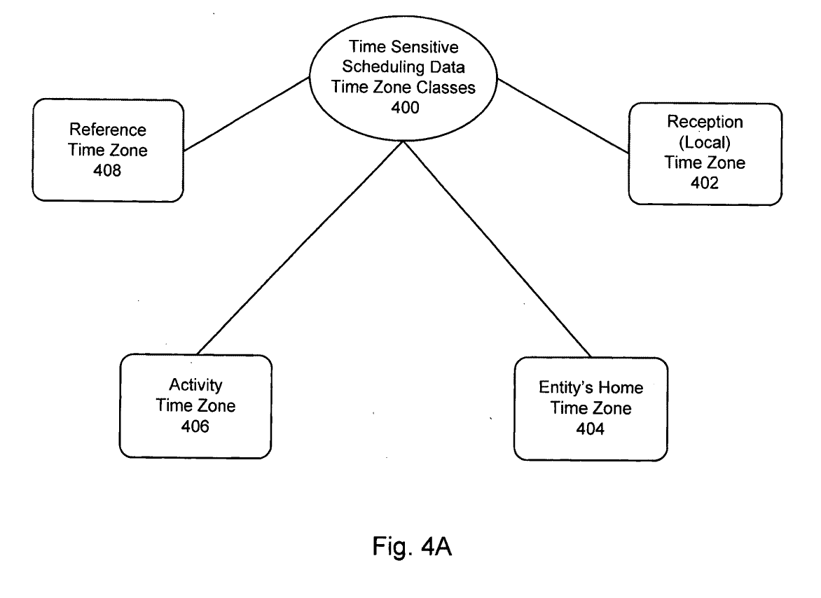

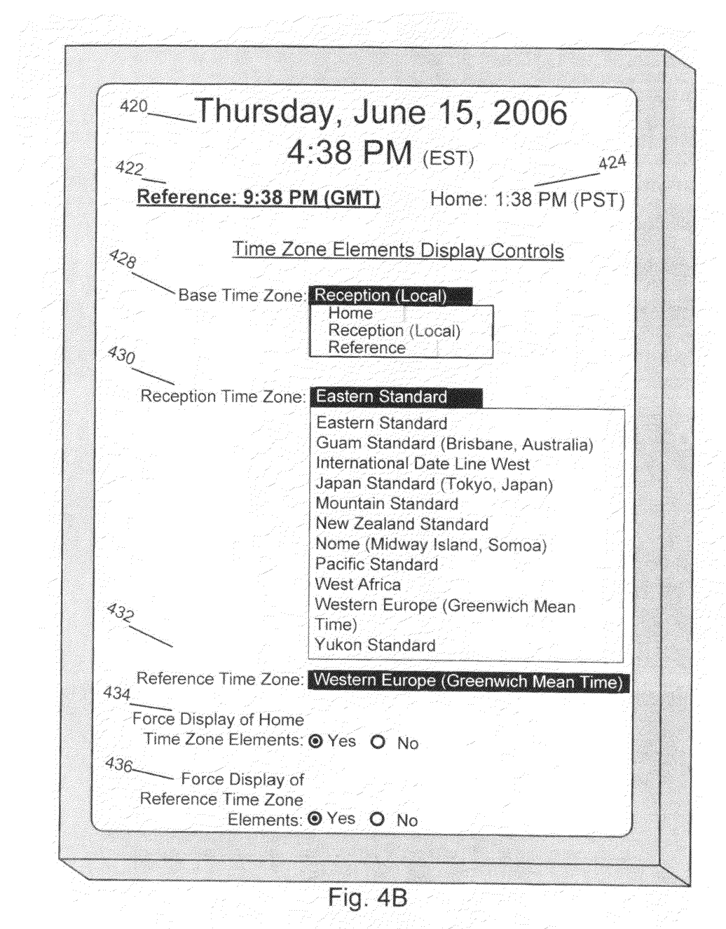

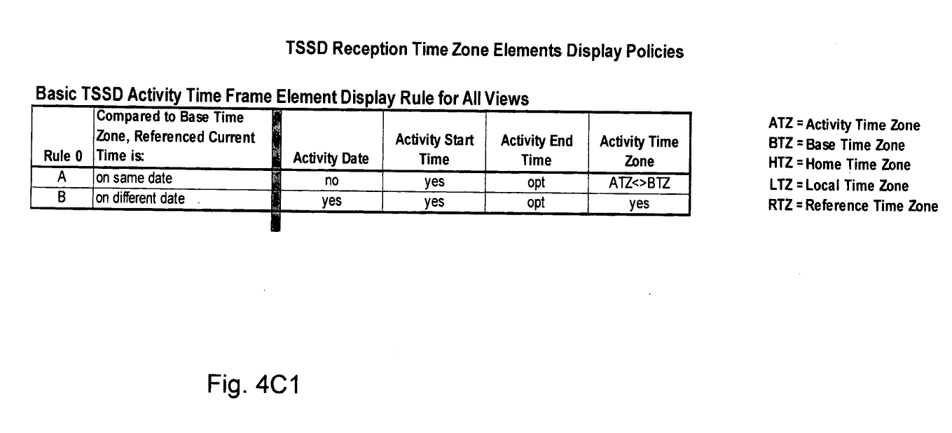

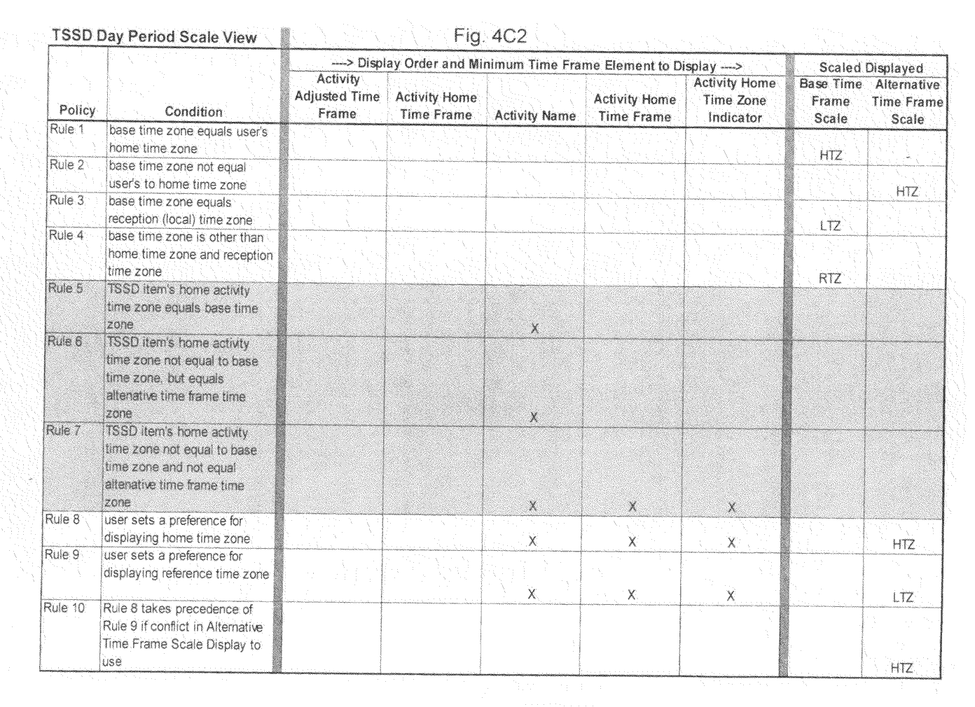

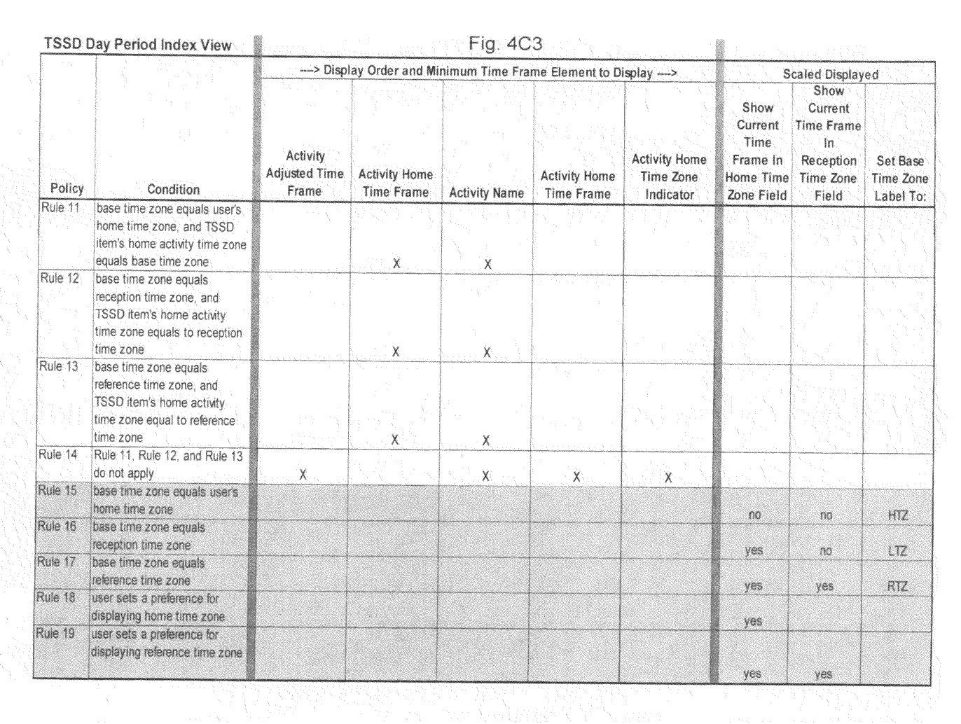

Referring now to FIG. 4A, depicted is a class diagram displaying TSSD Time Zone classes which may impact the TSSD Delivery Network's transmission of or display of TSSD content. The TSSD Time Zone Classes 400 are: the Reception (aka Local) Time Zone 402, the Entity's Home Time Zone 404, the Activity Time Zone 406, and the Reference Time Zone 408. In this context, the term time zone may refer to one of the time zones of the Coordinated Universal Time systems geographically designated time zones with allowances for geo-political adjustments. The Reception Time Zone 402 may be the local time zone where the TSSD is being displayed. This usually is, but may not always be where the TSSD receiving device is physically located. The Entity's Home Time Zone 404 may be the time zone where a subscribing entity physically resides, works, is headquartered or has significant operations. The Activity Time Zone 406 may be the time zone where the TSSD activity will take place, be held, be hosted or be designated as the primary coordination point. The Reference Time Zone 408 may refer to a time zone which is designated to be the “base time zone” of the TSSD display presentation when that designated time zone is neither the entity's reception time zone nor the entity's home time zone.

FIG. 4B is a sample screen display of a Time Zone Display Controls maintenance screen according to one or more embodiments of the invention. To specify time zone display preferences, the user may need to fill in the form on this screen or a similar screen and save the results. At the top of the form are fields reflecting the current time zone preference settings as they may appear on most TSSD receiving device display screens. The first field 420, the Base Time Zone Current Time field, can provide the current day, date, time and time zone indicator for the base time zone. In this example, the Base Time Zone field 428 indicates that the base time zone is set to be the Reception (Local) Time Zone field 430. Field 430 can indicate that the Reception Time Zone is set to be the East Standard Time Zone. Thus the Base Time Zone Current Time field 420 indicates that the current time in the Reception Time Zone is Thursday, Jun. 15, 2006 at 4:38 PM in the East Standard Time Zone (abbreviated “EST”). Force Display of Reference Time Zone Elements field 436 has “Yes” selected; Reference Time Zone field 432 indicates the chosen time zone for the reference time zone is the Western Europe (Greenwich Mean Time) Standard Time zone; and this has resulted in Reference Time Zone Time field 422 being displayed below the current time frame. The current time in the reference time zone is 9:38 PM Greenwich Mean Time zone (abbreviated “GMT”). In addition the Force Display of Home Time Zone Elements field 434 has “Yes” selected; and this has resulted in the User's Home Time Zone field 424 being displayed below the Base Time Zone Current Time field 420. The current time in the user's home time zone is 1:38 PM Pacific Standard Time (abbreviated “PST”).

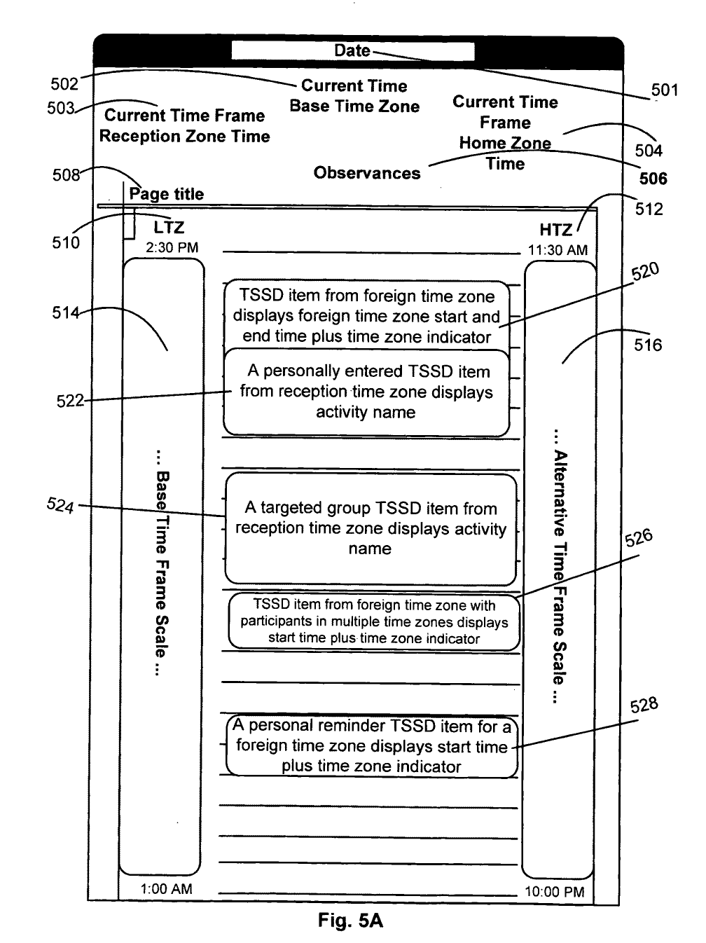

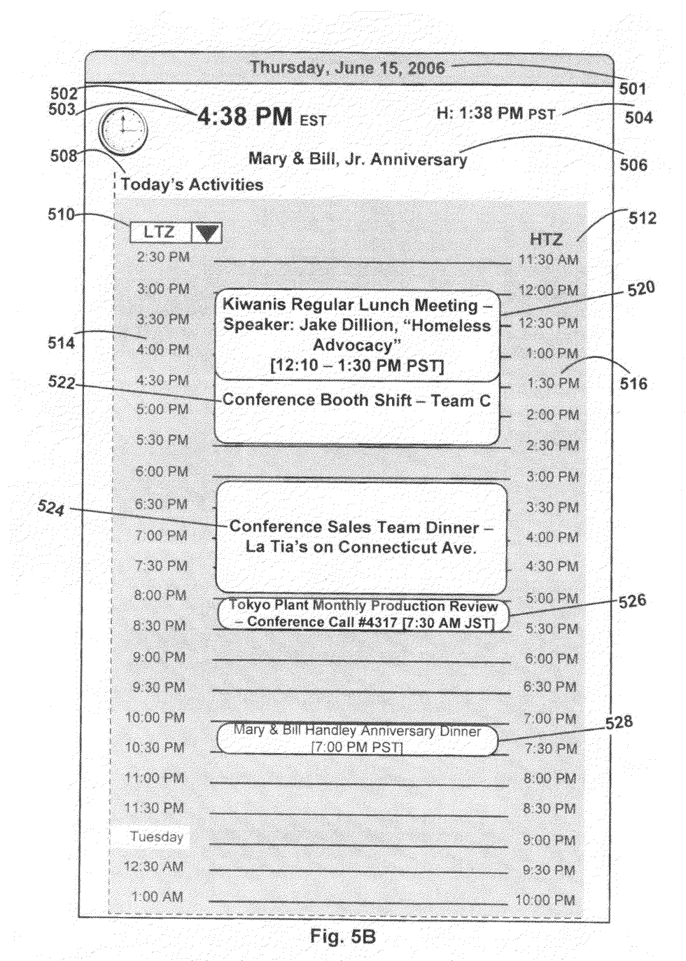

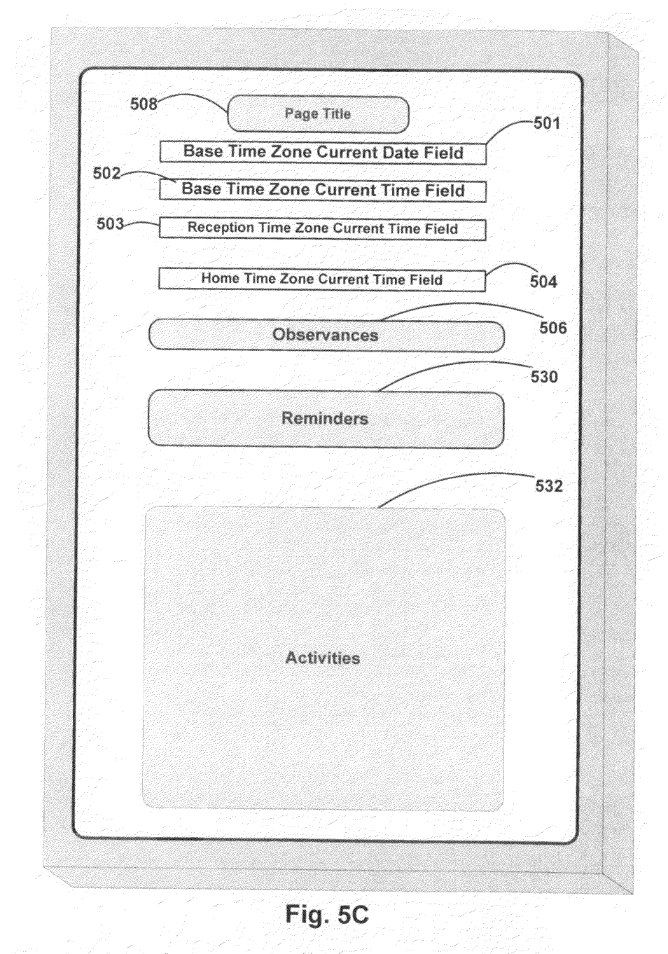

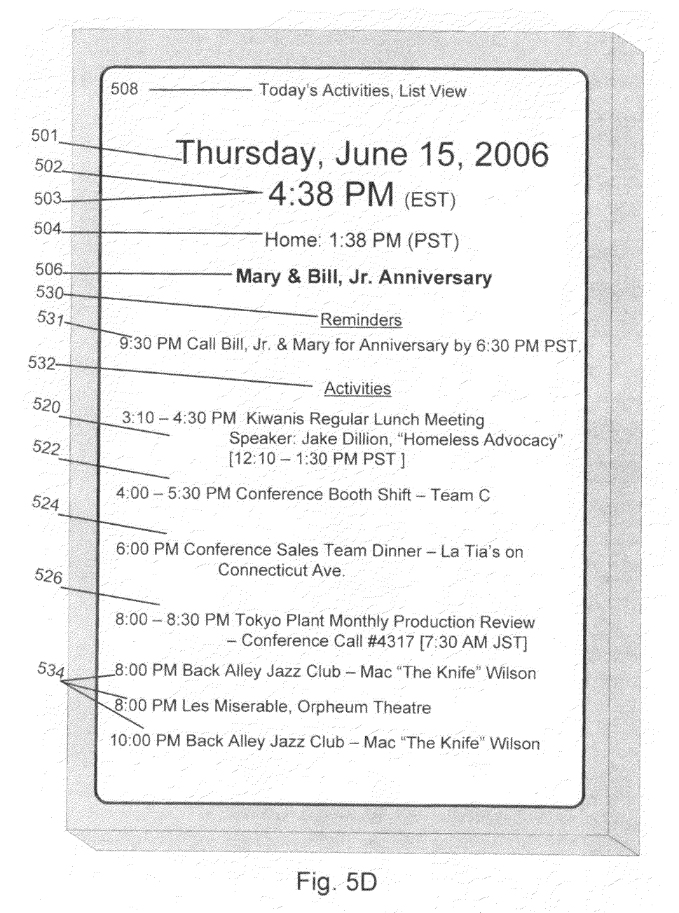

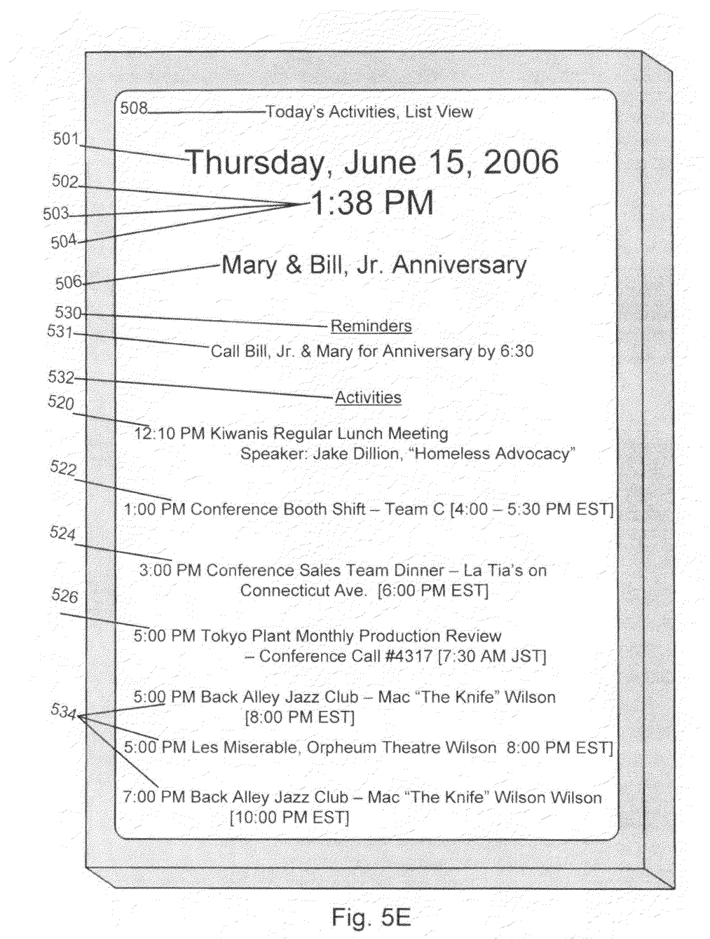

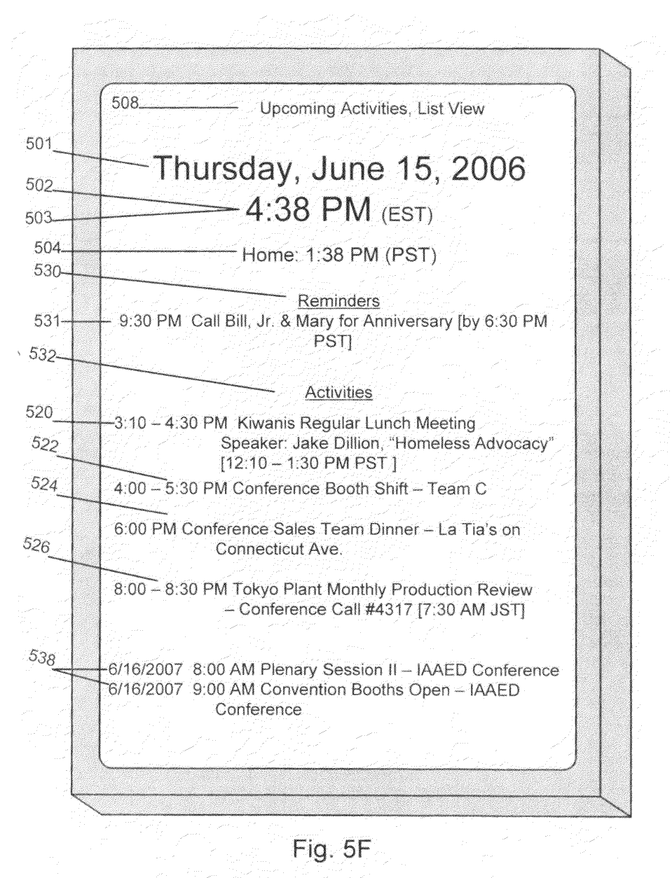

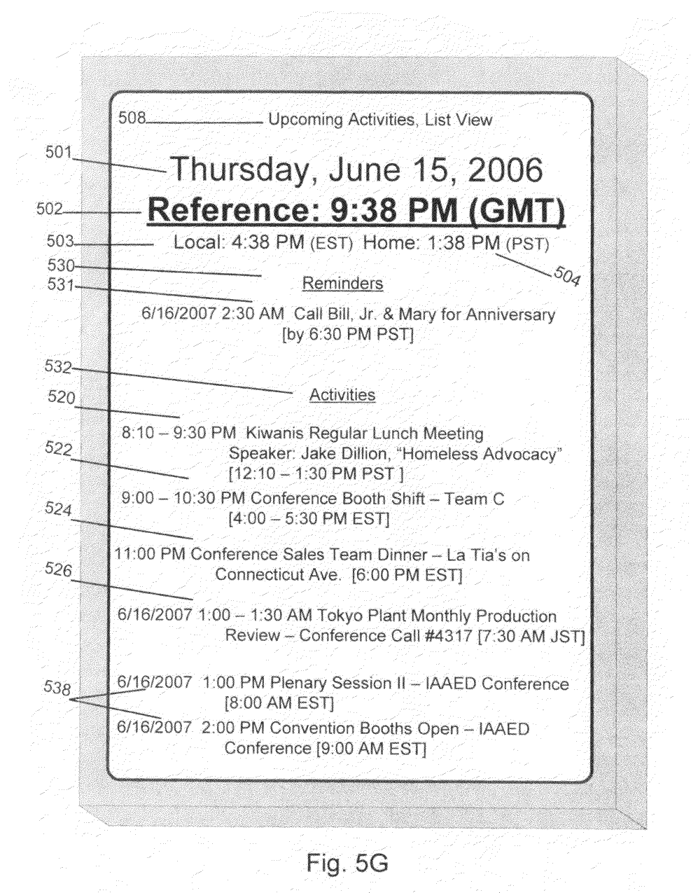

FIG. 4C displays the TSSD Reception Time Zone Elements Display Policies (rules) which may be applied to displaying each TSSD item in a display on a large screened TSSD receiving device in two scenarios: 1) the TSSD Day Period Scale View (reference FIGS. 5A-5B), where time frame scales are present and TSSD items are presented relative to the scales; and 2) the TSSD Day Period Index View (reference FIGS. 5C-5G), where time frame scales are not used and TSSD items are listed in chronological order within display categories. The policy rules are presented in declining order of precedence. Rule 0 may globally apply to the display of time frame elements. In one embodiment of the invention, Rules 1-10 may apply when time frame scales are present, and Rules 11-19 may apply when time frame scales are not present. A home TSSD item may be a TSSD item whose home activity time zone is the same as the base time zone. A foreign TSSD item may be a TSSD item whose home activity time zone differs from the base time zone.

In one embodiment, Rule 0 may apply to displaying any time frame such that, if the current time of that time frame occurs on the same date as the current time in the base time zone, then the TSSD activity item's start date and/or end date are not displayed; the activity start time is displayed; the activity end time is displayed if screen space allows; and the activity time zone indicator appears if the activity time zone differs from the base time zone. According to another embodiment, when displaying any time frame, if the current time of that time frame occurs on a different date than the current time in the base time zone, then the TSSD activity item's start date and/or end date are displayed; the activity start time is displayed; the activity end time is displayed if screen space allows; and the activity time zone indicator appears. For example, if the base time zone current time is 4:38 PM Eastern Standard Time and the activity's home time zone current time is 1:38 PM Pacific Standard Time, then the Home Time Zone Current Time may be displayed as: H: 1:38 PM PST (see FIG. 5B) or Home: 1:38 PM (PST) (see FIG. 5D).

Rule 1 may apply such that if the base time zone equals the user's home time zone, the user's home current date is shown in Base Time Zone Current Date Field 501 of FIG. 5A, the user's home current time is shown in Base Time Zone Current Time Field 502 and the Base Time Zone Time Frame Scale 514 is displayed using the home time zone period. The Home Time Zone Current Time Field 504 and the Reception Time Zone Current Time Field 503 are not displayed unless forced by Rule 8 and Rule 9 respectively. Rule 2 may apply such that if the base time zone is not the user's home time zone, the Home Time Zone Current Time Field 504 is displayed with the current time in the home time zone, and the Alternate Time Zone Time Frame Scale 516 is displayed in the home time zone period. Rule 3 may apply such that if the base time zone equals the reception time zone, i.e., the time zone where the TSSD receiving device is located, the local date is shown in Base Time Zone Current Date Field 501, the reference time zone's current time is shown in Base Time Zone Current Time Field 502 and the Base Time Zone Time Frame Scale 514 is displayed using the reference time zone period. Rule 4 may apply such that if the base time zone is a time zone other than the user's home time zone and the reception time zone, the Reception (local) Time Zone Current Time Field 503 is displayed with the local time frame where the TSSD receiving device is located; and the reference current date is shown in Base Time Zone Current Date Field 501; the reference current time is shown in Base Time Zone Current Time Field 502; and the Base Time Zone Time Frame Scale 514 is displayed using the reference time zone period. Rule 5 may apply such that if a TSSD item's home activity time zone is the same as the base time zone, the activity name of a TSSD item will be displayed adjacent to the base time zone time frame scale using the item's home time zone start time. Rule 6 may apply such that if a TSSD item's home activity time zone is not the base time zone (i.e., a foreign TSSD item), but is the same as the alternative time zone, then the TSSD item's activity name is displayed adjacent to the base time zone time frame scale using the item's home time zone start time converted to the base time zone. Rule 7 may apply such that if a TSSD item's home activity time zone is not the base time zone (i.e., a foreign TSSD item), and not the same as the alternative time zone, then the TSSD item's activity name, activity home time frame and time zone are displayed adjacent to the base time zone time frame scale using the item's activity home time zone start time converted to the base time zone. Rule 8 may apply such that if the user's sets a preference for forcing the display of the home time zone elements, the TSSD activity item's home time zone time frame elements, the home time zone current time field and the home time zone time frame scale (as the Alternative Time Zone Time Frame Scale 516) will be displayed even if they are redundant and/or otherwise unnecessary. Rule 9 may apply such that if the user's sets a preference for forcing the display of the reference time zone elements, the reference time zone current time field and the reference time zone time frame scale (as the Alternative Time Zone Time Frame Scale 516) will be displayed even if they are redundant and/or otherwise unnecessary. Rule 10 may apply such that if Rule 8 and Rule 9 are in conflict on which time zone scale to use as the alternative time frame scale, Rule 8 (the user's home time zone scale) takes precedence.

Rule 11 may apply such that if the base time zone is the user's home time zone and the TSSD activity item's home time zone is the same as the base time zone, then the TSSD activity item's home time frame followed by activity name is displayed in the Activities display zone 532, FIG. 5C. Rule 12 may apply such that if the base time zone is the reception time zone, and the TSSD activity item's home time zone is the same as the reception time zone, then the TSSD activity item's home time frame followed by activity name is displayed in the Activities display zone 532, FIG. 5C. Rule 13 may apply such that if the base time zone is the reference time zone and the TSSD activity item's home time zone is the same as the reference time zone then the TSSD activity item's home time frame followed by activity name is displayed in the Activities display zone 532, FIG. 5C. Rule 14 may apply such that if Rule 11, Rule 12 and Rule 13 do not apply to a TSSD activity item to be displayed, then the TSSD activity item's home time frame is adjusted to match the reception time zone. The TSSD activity item's adjusted time frame, activity name, and home activity time frame including the activity time zone indicator are displayed in the Activities display zone 532, FIG. 5C. Rule 15 may apply such that if the base time zone is the same as the user's home time zone, then the Base Time Zone Label (not shown) is set to the user's home time zone and the Home Time Zone Current Time Field 504 and Reception Time Zone Current Time Field 503 are not displayed unless forced by Rules 18 and 19 respectively. Rule 16 may apply such that if the base time zone is the same as the reception (local) time zone, then the Base Time Zone Label (not shown) is set to the local time zone; the Home Time Zone Current Time Field 504 is displayed using the user's home time zone's current time; and the Reception Time Zone Current Time Field 503 is not displayed unless forced by Rule 19. Rule 17 may apply such that if the base time zone is the same as the reference time zone, then the Base Time Zone Label (not shown) is set to the reference time zone; the Home Time Zone Current Time Field 504 is displayed using the user's home time zone's current time; and the Reception Time Zone Current Time Field 503 is displayed using the reference time zone's current time. Rule 18 may apply such that if the user's sets a preference for forcing the display of the home time zone elements, the Home Time Zone Current Time Field 504 is displayed using the user's home time zone's current time. Rule 19 may apply such that if the user's sets a preference for forcing the display of the reference time zone elements, the Home Time Zone Current Time Field 504 is displayed using the user's home time zone's current time, and the Reception Time Zone Current Time Field 503 is displayed using the reference time zone's current time.

FIGS. 5A and 5C provide schematics of TSSD receiving device display pages showing the locations of time frame and time zone reference items, time frame scales and TSSD item names according to one or more embodiments of the invention. FIG. 5B and FIGS. 5D-5G show examples of how individual TSSD items may appear in the various reception time zone display modes in accordance with one or more aspects of the invention. For ease of comparison and to facilitate the illustration of major points, all figures are presented in the same time frame and from the same pool of TSSD activity data. The differences reflected are from simulated time zone display preference selections by the user and/or receiving device profile preferences. The element identification numbers on the figures which are sample data corresponding to the element identification numbers on the schematic diagrams.

FIG. 5A shows a schematic of a TSSD Day Period Scale View display screen, its components area and sample data display legends according to one or more embodiments of the invention. FIG. 5B shows example data in the corresponding day period scale view display screen where the base time zone is the reception (local) time zone. In this example, a Base Time Zone Current Date Field 501 for the current date, a Base Time Zone Current Time Field 502 for the reference time zone, a Reception Time Zone Current Time Field 503 for the reception time zone, a Home Time Zone Current Time Field 504 for the user's home time zone, an Observances zone 506 for holidays and recognitions, a Page Title field 508, a Base Time Zone Time Frame Scale Indicator 510, a Base Time Zone Time Frame Scale 514, an Alternative Time Zone Time Frame Scale Indicator 512, an Alternative Time Zone Time Frame Scale 516 and various activity items 520, 522, 524, 526 and 528 are provided. These activity items are displayed in a manner along the time scales in a manner which indicates their respective starting and ending times in the base time zone, and, if selected for display, an alternative time zone. FIG. 5B shows that the current date 501 is Thursday, Jun. 15, 2006. The current time in the Base Time Zone Current Time Field 502 is 4:38 PM (EST). The current time is 1:38 PM (PST) in the user's Home Time Zone Current Time Field 504. There is one TSSD entry in the Observances zone 506 for this date: “Mary & Bill, Jr. Anniversary.” The display page has “Today's Activities” as its Page Title 508.

The five sample TSSD items shown in FIG. 5B and identified in FIG. 5A are from the following scenario: 1) the user who lives in San Jose, Calif. is a member of a service club (Kiwanis) and has subscribed to a TSSD channel for the user's Kiwanis Club's activities and they have a regular meeting at 12:10 PM each Monday; 2) the user is attending a conference in Washington, D.C. and has recorded TSSD entries for scheduled booth staffing duties from 4:00-5:30 PM and a sales team dinner from 6:00-8:00 PM; 3) the user is part of his company's regular Japanese manufacturing plant monthly production review meeting with the general manager which he usually participates in by conference call at 5:00 PM in the California sales office; and 4) the user is subscribed to his son and daughter-in-law's family activity channel where he has received a reminder of their anniversary dinner to which the family has been invited.

In FIG. 5B, the base time zone is the reception time zone, i.e., the local time zone where the user is located at this time, which happens to be the Eastern Standard Time Zone. So all TSSD may be presented relative to this reception time zone and the Time Zone Elements Display Policy Rules 0-10 which may apply. In addition, this user may have set a preference to display the home time on TSSD items from his home time zone, since the times would not normally be displayed as they are redundant when the home time zone time frame scale is shown (reference Rule 8). In this scenario, the Kiwanis regular meeting 520 is a TSSD item from a foreign time zone. It appears on the reception time zone time frame scale at 3:10 PM (Rule 6) and at 12:10 PM on the home time zone time frame scale. As this is a foreign TSSD item, the meeting is displayed with its home time zone starting time 12:10 PM, ending time 1:30 PM, and home time zone indicator “PST” (Rule 8). The conference booth staffing TSSD item 522 is displayed starting at the 4:00 PM and ending at 5:30 PM on the reception time zone time frame scale. As this is a local TSSD item, no further home time zone indicators are displayed (Rule 5). The same is true for the Conference Sales Team Dinner 524 which is displayed starting at 6:00 PM and ending at 8:00 PM. The Tokyo Plant Monthly Product Review Meeting Conference Call 526, which starts at 7:30 AM where the conference call is hosted, is a foreign TSSD item and appears on the reception time zone time frame scale at 8:00 PM and 5:00 PM on the user's home time zone time frame scale. It is displayed with its home time zone starting time of 7:30 AM plus the time zone indicator “JST” for (Japanese Standard Time) (Rule 7). Personal reminder TSSD item 528 “Mary & Bill Handley Anniversary Dinner” is another item from his home time zone which is in this context, a foreign TSSD item. It is displayed at 10:00 PM on the alternative time zone time frame scale and 7:00 PM (Rule 6).

FIG. 5C shows a schematic of a TSSD Day Period Index View display screen, its components areas plus sample data display legends according to one or more embodiments. FIGS. 5D-5G show example data in the corresponding day period index view display screens where 1) the base time zone is the reception (local) time zone: Eastern Time Zone, FIGS. 5D and 5F, 2) the base time zone is the user's home time zone: Pacific Time Zone, FIG. 5E and 3) the base time zone is a reference time zone: Western Europe Time Zone (Greenwich Mean Time), FIG. 5G. In these examples, there are the Base Time Zone Current Date Field 501 for the current date, a Base Time Zone Current Time Field 502 for the reference time zone, a Reception Time Zone Current Time Field 503 for the reception time zone, a Home Time Zone Current Time Field 504 for the user's home time zone, a Page Title field 508, an Observances zone 506 for holidays and recognitions, a Reminders zone 530 for TSSD reminder items 531, and an Activities zone 532 for various other TSSD activity items 520, 522, 524, 526, 534 and 538.

In the examples provided, the activity items are displayed in a manner consistent with Rules 11-19. FIGS. 5D and 5E show that the current date 501 is Thursday, Jun. 15, 2006. The current time in the Base Time Zone Current Time Field 502 is 4:38 PM (EST) in FIG. 5D; 1:38 PM (PST) in FIG. 5E; 4:38 PM (EST) in FIG. 5F; and 9:38 PM (GMT) in FIG. 5G. The current time is 1:38 PM (PST) in the user's Home Time Zone Current Time Field 504. There is one TSSD entry in the Observances zone 506 for this date: “Mary & Bill, Jr. Anniversary.” The display page has “Today's Activities” as its Page Title field 508.

In FIG. 5D, the base time zone is Eastern Standard Time and user's home time zone is Pacific Standard Time, so the Home Time Zone Current Time Field 504 appears showing “Home: 1:38 PM (PST).” The TSSD reminder item 531, a foreign item, is displayed beginning with the adjusted start time of 9:30 PM, followed by the activity name text and ending with the home time zone start time and time zone indicator (Rule 14). TSSD activity items 520 and 526 are displayed likewise. Local TSSD activity items 522, 524 and 534 are displayed according to Rule 12, and displayed with their start time and Activity name only.

In contrast, FIG. 5E shows the same TSSD items as FIG. 5D, but as they would appear on the display in the user's home time zone. Compare TSSD items 531 and 520 which are now local items in this context, displayed according to Rule 11. TSSD activity items 522, 524 and 534 are now foreign items and join TSSD activity item 526, the Tokyo Plant meeting, in being displayed according to Rule 14. In FIG. 5E, the Home Time Zone Current Time Field 504 is no longer displayed (Rule 15) as the user's home time zone is the same as the base time zone.

In contrast to FIG. 5D, FIG. 5F introduces TSSD activity items 538 to demonstrate the impact of Rule 0 on foreign items displayed when they occur on a different date than the current date in the base time zone. TSSD activity items 538 show a start date prefixed to their entry, for example, “6/16/2007 8:00 AM Plenary Session II—IAAED Conference.” This application of Rule 0 is compared with another foreign TSSD activity item 526 which shows no date because the activity occurs on the same date as the base time zone, and appears as “8:00-8:30 PM Tokyo Plant . . . #4317 [7:30 AM JST].”

FIG. 5G introduces the condition of a foreign TSSD item occurring on a different date because of the user's choice of the reference time zone: Greenwich Mean Time. That selection when combined with the current time in the reference time zone 9:38 PM, results in the Tokyo Plant Meeting's adjusted time frame occurring on a different date 6/16/2007 than the base time zone current date of 6/15/2007. This TSSD activity item 526 now has the date prefixed and appears as: “6/16/2007 1:00-1:30 PM Tokyo Plant . . . #4317 [7:30 AM JST].” In TSSD presentation shown in FIG. 5G, Base Time Zone Current Time Field 502 reflects the reference time zone. In addition, per Rule 17, both the Reception (Local) Time Zone Current Time Field 503 and the User's Home Time Zone Current Time Field 504 may appear. The choice of the reference time zone has also resulted in all TSSD items becoming foreign items and therefore being displayed with their home time zone current time field appended to the end of the display entry.

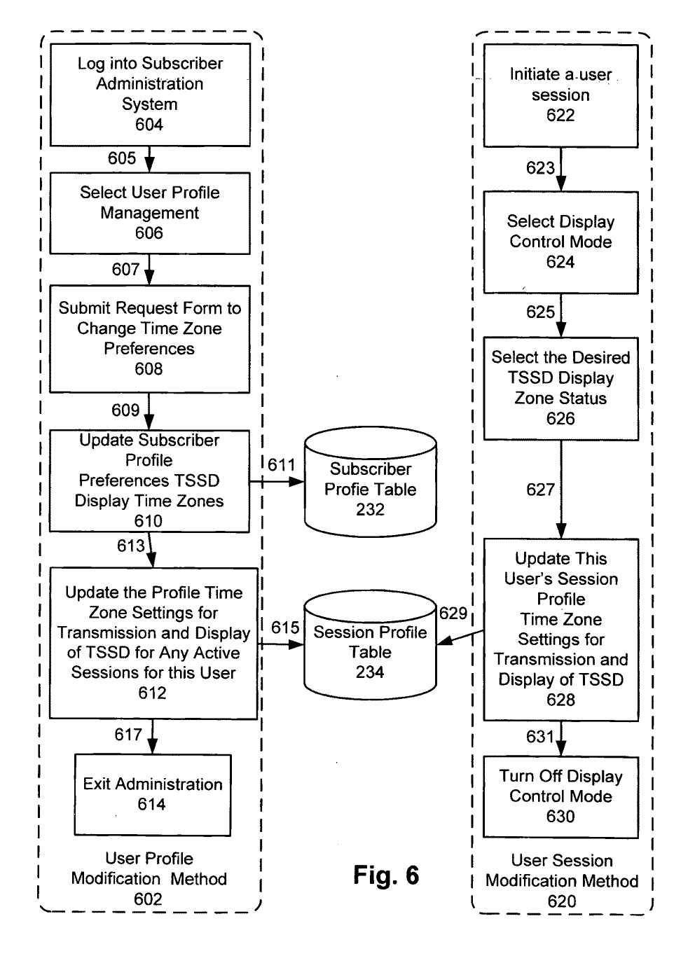

FIG. 6 shows a flowchart of two TSSD Time Zone specification methods which a user may use to specify a desired time zone presentation for displayed TSSD according to one embodiment of the invention. The User Profile Modification Method 602 may allow the user to set a reception time zone presentation that remains in effect until the setting is modified by the user, i.e., the reception time zone presentation all future session until changed by the user. The User Session Modification Method 620 may allow the user to set a reception time zone presentation mode which effects only this user session and may remain in effect until the current user session ends, until the user may make another session modification or until the reception time zone presentation setting may be modified by the User Profile Modification Method 602.

Using the User Profile Modification Method 602 to set the Reception Time Zone Presentation Mode, the user may log into the Subscriber Administration System 604. Next, the user on line 605 may select the User Profile Management Function 606. Within this function, the user on line 607 may then submit a Submit Request Form to Change Time Zone Preferences 608. The Reception Time Zone Presentation mode selection may then be transmitted on line 609 to the Update Subscriber Profile Preferences TSSD Display Time Zones Function 610. The Update Subscriber Profile Preferences TSSD Display Time Zones Function 610 may update on line 611 the user's subscriber profile in the Subscriber Profile Table 232, and may forward the Reception Time Zone Presentation Mode selection on line 613 to a function which may update any active session profiles for this user. The Update the Profile Time Zone Settings for Transmission and Display of TSSD for Any Active Sessions for this User Function 612 may update active session profiles on line 615 in Session Profile Table 234. The user may end this method by Exiting the Administrative Function 614 on line 617.

Using the User Session Modification Method 620 to set the Reception Time Zone Presentation Mode Setting for the current user session, the user may initiate a User Session at 622. Next the user may select to transition to the Display Control Mode Function 624 on line 623 and may select to transition to the Select the Desired TSSD Display Zone Status Function 626 on line 625. The Select the Desired TSSD Display Zone Status Function 626 may present a set of reception time zone presentation display options to the user and may forward the user's selection on line 627 to a function which may update the user's session profile. The Update This User's Session Profile Time Zone Settings for Transmission and Display of TSSD Function 628 via path 629 may update the user's session profile in the Session Profile Table 313. The user may end this method by Turning off Display Control Mode 630 on line 631.

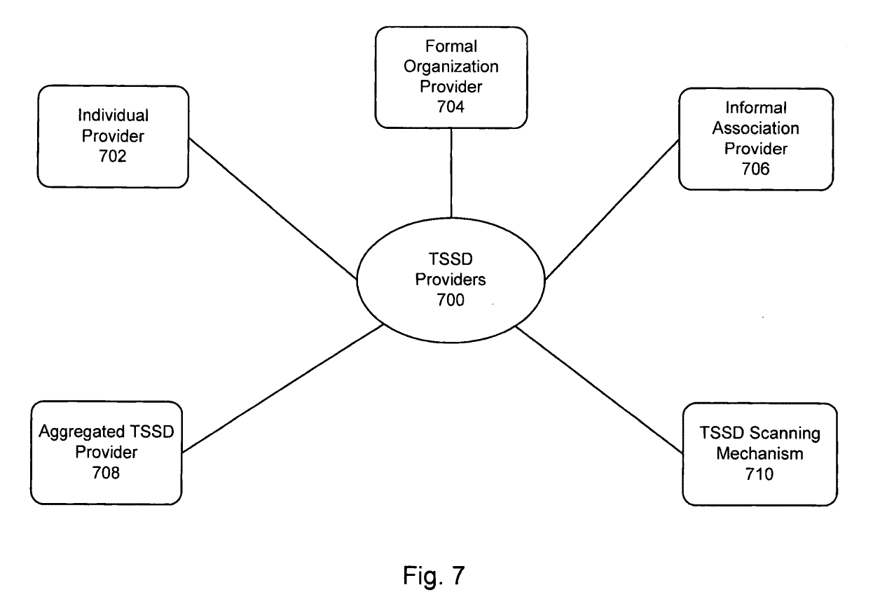

FIG. 7 is a class diagram illustrating providers of the specific TSSD used in the invention according to an embodiment of the invention. In the class diagram are described the TSSD Providers 700. TSSD Providers 700 may be the originating entities for the event or activity or they may be merely submitting TSSD attributes of events, meeting, activities, and observances (see e.g., FIG. 9).

The Individual Provider 702 of FIG. 7 may be any person acting in their own interest who may provide TSSD related to their own activities.

A Formal Organization Provider 704 may correspond to an organization which is certified by any authority generally recognized as a governing body and which has a formalized membership and leadership structure that may provide TSSD based on its own activities or group interests using the TSSD reception time zone method. Examples of Formal Organization Providers 704 may include companies with staff, trade associations like the American Bar Association, little league sports teams, and fan clubs.

An Informal Association Provider 706 may correspond to an informal group of individuals or groups which have a loose membership and leadership structure and simple affiliation mechanism. An Informal Association Provider 706 may also be a group of individuals that share common characteristics or derived interests but are loosely or not formally organized. An Informal Association Provider 706 may provide TSSD based on its own activities or group interests using the TSSD reception time zone method. Examples of Informal Association Provider 706 groups may include pickup sports teams, adult league sports teams, internet social networks, groups of school friends, and ad-hoc parents groups at schools.

An Aggregated TSSD Provider 708 may be an entity that may submit TSSD using the TSSD reception time zone method in bulk or aggregated form. Aggregated TSSD Providers 708 may submit TSSD which may generally not be the result of their own activities, but may be a collection of activities originated by other organizations that Aggregated TSSD Provider 708 may publish for the benefit of others. Examples of Aggregated TSSD Providers 708 may include chambers of commerce and media publication companies such as newspaper, magazine, and radio/TV broadcasters.

Finally, a TSSD Scanning Mechanism 710 may be a mechanism which harvests TSSD by searching data posted on the internet or published in print and radio/TV media. The scanning mechanism may be automated as with software tools which can search internet websites or manual labor who scan published media. Examples of TSSD Scanning Mechanism 710 are search-engine targeted at TSSD data and call centers targeting entertainment venues for information about upcoming events.

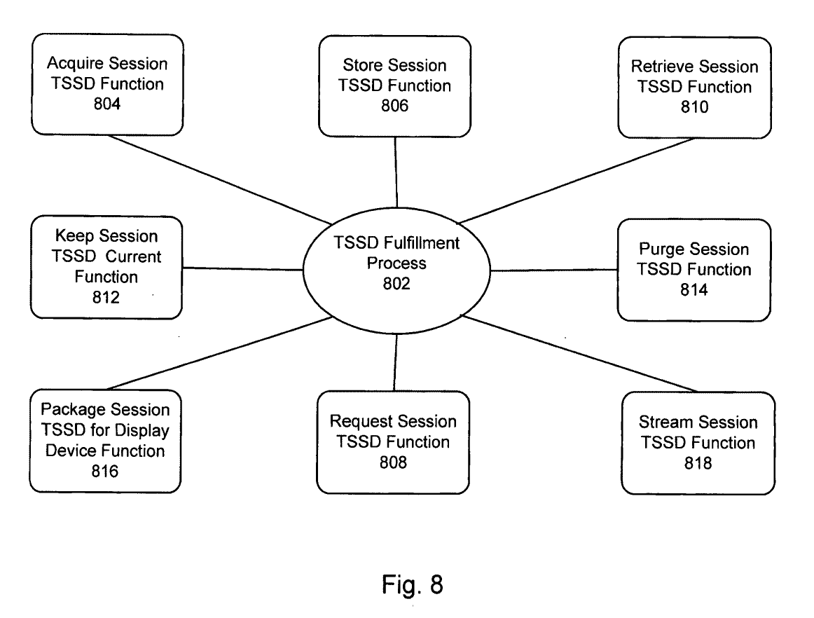

FIG. 8 shows an object diagram displaying the primary activity functions of the TSSD fulfillment process according to one embodiment of the invention. The TSSD Fulfillment Process 802 may be the central activity of the TSSD delivery network and can be coordinated by the Fulfillment Server 350 described earlier and depicted in FIG. 3B. The primary activity functions embodied in the TSSD fulfillment process may be Acquire Session TSSD Function 804, Store Session TSSD Function 806, Requesting Session TSSD Function 808, Retrieve Session TSSD Function 810, Keep Session TSSD Current Function 812, Purge Session TSSD Function 814, Package Session Function TSSD for Display Device Function 816 and Stream Session TSSD Function 818 to receiving devices. Session TSSD may refer to TSSD flowing through the TSSD delivery network relevant to a specific user during that user's current network session. The session TSSD data stream may include announcements, schedules, events, meetings, activities of associations and affinity groups, and promotional content.

The TSSD Fulfillment Process 802 may gather all the necessary information and functions to build a TSSD data stream for a user's current session. The Acquire Session TSSD Function 804 may interrogate the user's profiles and preferences then may determine what TSSD should be acquired to create the TSSD data stream for the user's current session. The Request Session TSSD Function 808 may prepare the appropriate network request objects for the Retrieve Session TSSD Function 810 to obtain the TSSD for the user's current session. The Retrieve Session TSSD Function 810 may issue the necessary extraction requests across the TSSD delivery network to obtain the TSSD for the current session. The Store Session TSSD Function 806 may aggregate and store the retrieved TSSD, TSSD extraction requests and user preferences in preparation for transmitting the resulting TSSD data stream to the user. The Package Session TSSD for Display Device Function 816 may modify the TSSD data to accommodate display functionality requirements on the user's receiving device. The Stream Session TSSD Function 818 may assemble the TSSD stream for the user's current session and may transmit the TSSD data stream. The Keep Session TSSD Current Function 812 may modify the TSSD extraction requests and preferences as necessary to maintain the currency of the TSSD data stream during the user's current session. The Purge Session TSSD Function 814 may remove TSSD from the data stream when it expires or no longer meets the preference requirements of the user for the current session.

Various activity data collection mechanisms may enable TSSD Fulfillment Process 802 to create the TSSD data stream for a user session. Activity data collection mechanisms may include various multi-platform, multi-communications TSSD receiving devices or web browsers. These TSSD receiving devices may include simple devices, advanced devices, embedded systems devices, individual access devices (e.g., cellular phones, PDAs), and community access devices (e.g., set tops equipped with input devices, kiosks ) or these web browsers may include PDAs, PCs, cellular phones, tablet PCs. Other data collection mechanisms may include call centers that provide direct contact information transfers and bulk purchase of activity data from vendors.

In one embodiment, the Stream Session TSSD Function 818 may assemble a data stream containing one or more profiled and prioritized feed packets of content known as a channel. The channel is now ready to be transmitted to windows in display devices. The display devices may be portable or fixed placement. The portable display devices may include mobile computing devices, PDAs, cellular phones, personal computers, portable workstations, and a combination thereof. The fixed placement display devices may include public place business display screens, home entertainment appliance displays, business display screens in a public place, business display screens on company property in public areas, business display screens on company property in private areas, and a combination thereof.

FIG. 9 is an objects diagram illustrating the basic attributes of TSSD 900 according to an embodiment of the invention. In the objects diagram may be defined sets of TSSD attributes. These TSSD Attributes 900 include: Time Zone of Activity Location or Coordination 902; Start Time/End Time 904; Start Date/End Date 906; Name 908; Source/Owner 910; Target Audience 912; Display Parameters 914 which may include graphics, logos, captions, and colors; Visibility Parameters 916 (e.g., posting date, hide flag); Administration Parameters 918 (e.g., who created, when created); Description of Activity 920; Host of Activity 922; and Location 924.

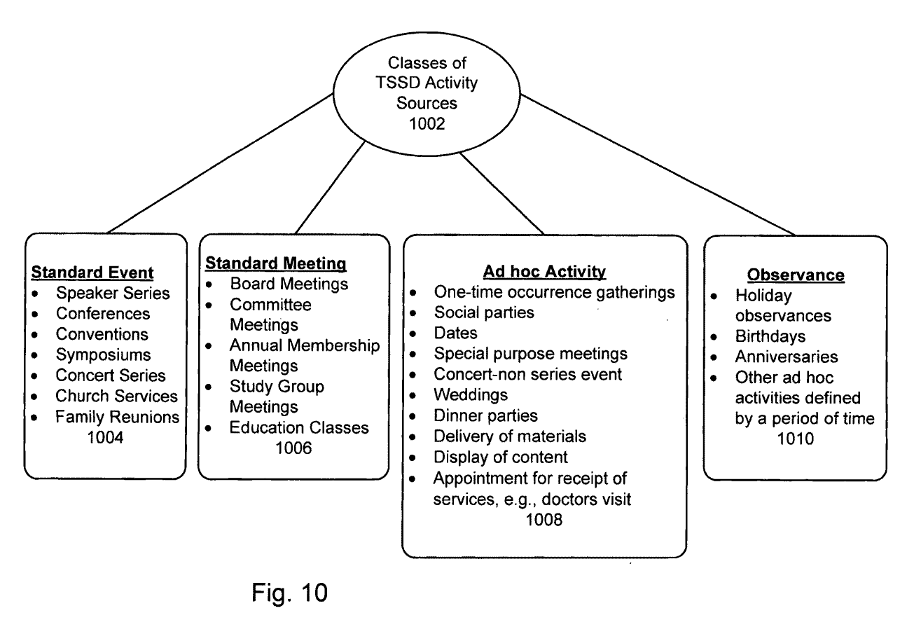

FIG. 10 is a class diagram illustrating the classes of TSSD Activity Sources 1002 according to an embodiment of the invention. In the class diagram are described common TSSD Activity Sources. These classes for TSSD Activity Sources 1002 may include Standard Events 1004, Standard Meetings 1006, Ad Hoc Activities 1008, and Observances 1010. The term gathering, as used herein, should be considered in a metaphorical context and is not be intended to indicate only geographic presence or proximity. For example, in celebrating holidays or life events (e.g., birthdays or wedding anniversaries), a number of people give credence or significance to a period or point in time, but do not necessary gather together in the same geographic space.

Standard Meetings 1006 may relate to generally recurring gatherings of the same individuals for the purpose of conducting the business of the association. Standard Meetings 1006 may include board meetings, committee meetings, annual membership meeting, study group meeting, delegate conventions, and educational classes.

Standard Events 1004 may relate to routine and non-routine gatherings of the same or ad hoc groups of individuals in association for purposes other than conducting the regular business of the associations. Standard Events 1004 may include speaker series, educational conferences, symposiums, concert series, church services, and family reunions.

Ad Hoc Activities 1008 may encompass all other pre-announced gatherings of individuals for social purposes. Ad Hoc Activities 1008 may include ad hoc associations, one-time occurrence gatherings, social parties, social dates, special purpose/ad hoc meeting, non-series concerts, weddings, dinner parties and logistical events such as the delivery of materials, displays of some content or an appointment to receive services. Observances 1010 include routine recognition of a holiday or special activity date such as Election Day or tax due date and ad hoc life events such as a birth or a marriage.

Observances 1010 may be mass recognitions of an ad hoc event or may be ad hoc or routine gatherings of the same or ad hoc groups of individuals in association for purposes of commemorating an event or occurrence. Observances 1010 may include routine recognition of a holiday or special activity date such as Election Day or tax due date and ad hoc life events such as a birth or a marriage.

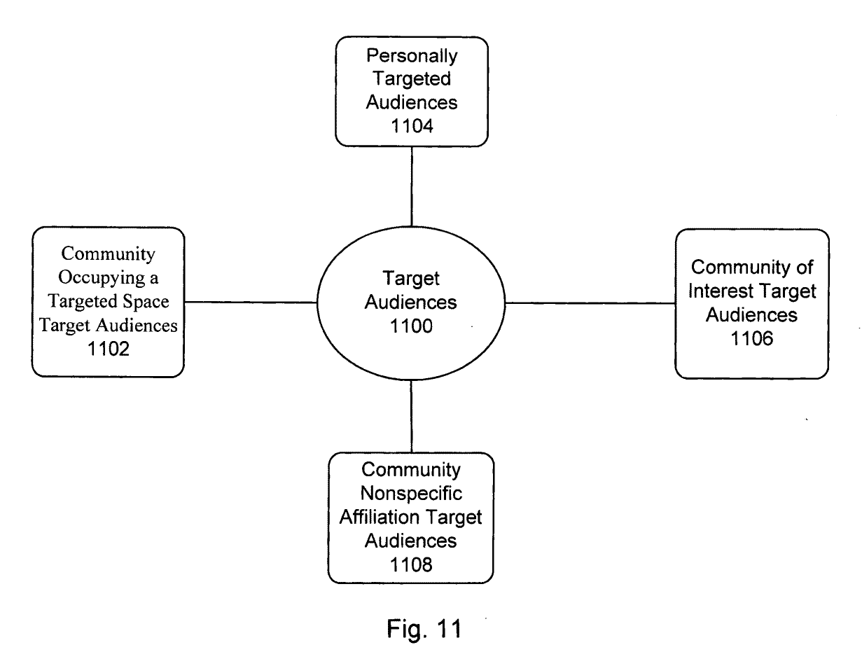

FIG. 11 is a class diagram illustrating the target audiences according to an embodiment of the invention. As shown in the class diagram, the primary audience classes of Target Audiences 1100 are displayed.

In one embodiment, Personally Targeted Audiences 1104 may be individuals to whom specific TSSD and promotional material are streamed based on the attributes and preferences explicit in their personal profile. Personally Targeted Audiences 1104 may include audiences targeted by self-chosen membership or direct affiliation with a TSSD delivery network related product client. Examples of Personally Targeted Audiences 1104 may be at least one of active members of a service or social club, lapsed members of a trade association, board members of a not-for-profit organization, board members, staff or clients of a business, and individual subscribers using the TSSD delivery network services.

Community of Interest Target Audiences 1106 may correspond to audiences who share identified common affiliations deemed significant for this invention and to whom specific TSSD and promotion materials are streamed based on their affiliations, the common attributes derived for the community group, and the specific preferences of significant members of the community group. Community of Interest Targets 1106 may include dentist, alumni of a college fans of an artist or genre of music, and wine lovers who prefer cabernet sauvignon.

In one embodiment, Community Nonspecific Affiliation Target Audiences 1108 may be audiences who share identified common attributes deemed significant for this invention and to whom specific TSSD and promotion materials are streamed based on the common attributes and affiliations derived for the community group, and the specific preferences of significant members of the community group. Community Nonspecific Affiliation Target Audiences 1108 may include adults age 26-35 or people who attended a conference on space exploration last year.

According to another embodiment, Community Occupying a Targeted Space Target Audiences 1102 may be audiences who share a common space (physical or virtual) at a targeted time deemed significant and to whom specific TSSD and promotion materials are streamed based on the occupancy of that space at that time. Community Occupying a Targeted Space Target Audiences 1102 sharing a physical space may include sports, concert, performing arts event attendees, attendees of conferences and conventions, attendees at public festivals such as art and wine festivals or food festivals, attendees at political rallies and attendees at private events such as weddings, roasts, church services or observances. Community Occupying a Targeted Space Target Audiences 1102 sharing a confined space may also include passengers on a bus, boat, plane or train. Community Occupying a Targeted Space Target Audiences 1102 sharing a virtual space may include all internet users browsing a particular organization's website, all phone users participating in a conference call, all attendees to a virtual web conference.

The invention is preferably implemented by software, but can also be implemented in hardware or combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The drawings and the foregoing description gave examples of the present invention providing a TSSD Reception Time Zone Presentation of Time Sensitive Scheduling Data method and related aspects. Although depicted as a number of disparate functional items, those skilled in the art will appreciate that one or more of such elements may well be combined into at least one single functional entity. Alternatively, certain elements may be split into multiple functional elements. The scope of the present invention, however, is by no means limited by these specific examples. Numerous variations, whether explicitly given in the specification or not, such as differences in structure, dimension, and use of material, are possible. Although the present invention has been described in considerable detail with reference to certain embodiments thereof, the invention may be variously embodied without departing from the spirit or scope of the invention. Therefore, the following claims should not be limited to the description of the embodiments contained herein in any way.

What is claimed is:

1. A method for presenting time frame elements of time sensitive scheduling data to an entity based on a reception time zone related to a passive delivery via a time sensitive scheduling data delivery network, the method comprising:
accommodating a communications network passive delivery of time zone
adjusted time sensitive scheduling data to an entity; aggregating into time sensitive scheduling data streams, specific time zone adjusted time sensitive scheduling data from originating organizations, affiliated groups of individuals, and individuals;
transmitting via the communications network specific time zone adjusted time sensitive scheduling data streams aggregated from multiple originating organizations, affiliated groups of individuals, and individuals to the entity; and
presenting time sensitive scheduling data and notices of upcoming time sensitive scheduling data activities in a dynamically adjusted manner affording the time zone adjustment based on a reception time zone in which the time sensitive scheduling data is being presented.

2. The method of claim 1, wherein the time sensitive scheduling data consists of data relating to a class of entity activities originating from a class of time sensitive scheduling data activity sources.

3. The method of claim 2, wherein the class of entity activities is selected from the group consisting of attending, timely participating, scheduling, planning, organizing, timely responding, reserving, and a combination thereof.

4. The method of claim 2, wherein the class of time sensitive scheduling data activity sources is selected from the group consisting of standard events, standard meetings, ad hoc activities, observances, and a combination thereof.

5. The method of claim 1, further comprising:
transforming home time frame elements of time sensitive scheduling data in a manner affording time frame identification in the reception time zone in which the time sensitive scheduling data item is being transmitted and presented.

6. The method of claim 5, wherein transforming consists of exposing time zone indicators, and wherein exposing time zone indicators represents the amount of presentation necessary to communicate when an activity occurs in its home time zone relative to the reception time zone where the activity is being presented.

7. The method of claim 5, wherein transforming occurs within a programming function at the sourcing data center for transmission and on capable time sensitive scheduling data receiving devices for presentation.

8. The method of claim 1, further comprising:
establishing the reception time zone presentation state for transmission and presentation of time sensitive scheduling data according to a base time zone for displaying and playing the time sensitive scheduling data.

9. The method of claim 1, further comprising:
establishing the reception time zone presentation state for transmission and presentation of time sensitive scheduling data according to a designated reception time zone for the time sensitive scheduling data.

10. The method of claim 1, further comprising:
establishing the reception time zone presentation state for transmission and presentation of reminder time sensitive scheduling data according to a receiving entity's reception time zone presentation preference for time sensitive scheduling data, the closeness to start time for the reminder time sensitive scheduling data activity, and a device receiving the reminder time sensitive scheduling data.

11. The method of claim 10, wherein the reminder time sensitive scheduling data is selected from the group consisting of receiving entity designated reminder items, receiving entity tagged reminder items, time sensitive scheduling data treated as observances, and a combination thereof.

12. The method of claim 10, wherein establishing the reception time zone presentation state consists of setting the reminder time sensitive scheduling data item's visibility attribute state to show item and representations of the item when presented, and setting the item's play attribute state to play item when presented, whenever the current time in the designated reception time zone falls within the reminder time sensitive scheduling data item's visibility and play activation time frame offset from the starting time of the time sensitive scheduling data on which the reminder time sensitive data item is based.

13. The method of claim 10, wherein establishing the reception time zone presentation state consists of setting observances time sensitive scheduling data item's visibility attribute state to show item and representations of the item when the current date in the designated reception time zone falls on the same date as the time sensitive scheduling data item being treated as an observance.

14. The method of claim 1, further comprising:
establishing the reception time zone presentation state for transmission and presentation of reservation time sensitive scheduling data according to a receiving entity's presentation reception time zone presentation preference for time sensitive scheduling data, the closeness to start time for the reservation time sensitive scheduling data activity, and a device receiving the reservation time sensitive scheduling data.

15. The method of claim 14, wherein the reservation time sensitive scheduling data is selected from the group consisting of alerts, reminders, warnings, and time period count downs associated with appointments, pre-arranged blocks of time set aside to receive services for the group of services including transportation reservations, medical appointments, vehicle repair reservations, dinner reservations, and a combination thereof.

16. The method of claim 14, wherein establishing the reception time zone presentation state consists of setting the reservation time sensitive scheduling data item's visibility attribute state to show item and representations of the item when presented, and setting the item's play attribute state to play item when presented, whenever the current time in the designated reception time zone falls within the reservation item sensitive scheduling data item's visibility and play activation time frame offset and the current time has not passed beyond the starting time of the time sensitive scheduling data on which the reservation time sensitive data item is based.

17. The method of claim 5, wherein the time frame adjustment afforded is based on the representation of a time sensitive scheduling data item within a communication transmitted from the data center source data store to the receiving device.

18. The method of claim 1, wherein presenting time sensitive scheduling data consists of receiving, transforming, displaying and playing time sensitive scheduling data.

19 The method of claim 1, wherein the representation of the time zone indicators of a time sensitive scheduling data item range from presenting no indicator to presenting a home start time, a home end time, a home time zone indicator, a home time zone of the time sensitive scheduling data item, reception time zone start time, reception time zone end time, reception time zone indicator, reference time zone start time, reference time zone end time, and reference time zone indicator.

20. The method of claim 1, further comprising:
adjusting reception time zone presentation to a time sensitive scheduling data delivery network user by presenting a time sensitive scheduling data item's time frame in accordance with a time sensitive scheduling data receiving device's profile and assigned preference.

21. The method of claim 20, wherein the time sensitive scheduling data receiving device's preference is assigned based on device capabilities.

22. The method of claim 20, wherein the time sensitive scheduling data receiving device's preference is assigned based on receiving entity preferences for the receiving device.

23. A system for presenting time frame elements of time sensitive scheduling data to an entity based on a reception time zone related to a passive delivery via a time sensitive scheduling data delivery network, the system comprising:
a time sensitive scheduling data center for storing time frame elements of time sensitive scheduling data, collecting time frame elements of time sensitive scheduling data from a providing entity, and sending time frame elements of time sensitive scheduling data to a consuming entity;
connectivity medium communication interfaces for transmitting time frame elements of time sensitive scheduling data between the time sensitive scheduling data center, a communication technology, and a time sensitive scheduling data receiving device;
a communication technology suitable for receiving and sending the passive delivery of time frame elements of time sensitive scheduling data;
processors for processing executable instructions for: accommodating a communications network passive delivery of time zone adjusted time sensitive scheduling data to an entity;
aggregating into time sensitive scheduling data streams, specific time zone adjusted time sensitive scheduling data from originating organizations, affiliated groups of individuals, and individuals;
transmitting via the communications network specific time zone adjusted time sensitive scheduling data streams aggregated from multiple originating organizations, affiliated groups of individuals, and individuals to the entity; presenting time sensitive scheduling data and notices of upcoming time sensitive data activities in a dynamically adjusted manner affording the time zone adjustment based on a reception time zone in which the time sensitive scheduling data is being presented; and
a time sensitive scheduling data receiving device for receiving and sending time frame elements of time sensitive scheduling data to the time sensitive scheduling data center via the connectivity medium communication interfaces via the communication technology.

24. The system of claim 23 further comprising:
a processor for processing an executable instruction for transforming home time frame elements of time sensitive scheduling data in a manner affording time frame identification in the reception time zone in which the time sensitive scheduling data item is being transmitted and presented.

25. The system of claim 24, wherein transforming consists of exposing time zone indicators, and wherein exposing time zone indicators represents the amount of presentation necessary to communicate when an activity occurs in its home time zone relative to the reception time zone where the activity is being presented.

26. The system of claim 24, wherein transforming occurs within a programming function at the sourcing data center for transmission and on capable time sensitive scheduling data receiving devices for presentation.

27. The system of claim 24, further comprising:
a processor for processing an executable instruction for establishing the reception time zone presentation state for transmission and presentation of time sensitive scheduling data according to a base time zone for displaying and playing the time sensitive scheduling data.

28. The system of claim 23, further comprising:
a processor for processing an executable instruction for establishing the reception time zone presentation state for transmission and presentation of time sensitive scheduling data according to a designated reception time zone for the time sensitive scheduling data.

29. The system of claim 23, further comprising:
a processor for processing an executable instruction for establishing the reception time zone presentation state for transmission and presentation of reminder time sensitive scheduling data according to a receiving entity's reception time zone presentation preference for time sensitive scheduling data, the closeness to start time for the reminder time sensitive scheduling data activity, and a device receiving the reminder time sensitive scheduling data.

30. The system of claim 29, wherein the reminder time sensitive scheduling data is selected from the group consisting of receiving entity designated reminder items, receiving entity tagged reminder items, time sensitive scheduling data treated as observances, and a combination thereof.

31. The system of claim 23, further comprising:
a processor for processing an executable instruction for establishing the reception time zone presentation state for transmission and presentation of reservation time sensitive scheduling data according to a receiving entity's presentation reception time zone presentation preference for time sensitive scheduling data, the closeness to start time for the reservation time sensitive scheduling data activity, and a device receiving the reservation time sensitive scheduling data.

32. The system of claim 31, wherein the reservation time sensitive scheduling data is selected from the group consisting of alerts, reminders, warnings, and time period count downs associated with appointments, pre-arranged blocks of time set aside to receive services for the group of services including transportation reservations, medical appointments, vehicle repair reservations, dinner reservations, and a combination thereof.

33. The system of claim 24 wherein the time frame adjustment afforded is based on the representation of a time sensitive scheduling data item within a communication transmitted from the data center source data store to the receiving device.

34. The system of claim 23, wherein the representation of the time zone indicators of a time sensitive scheduling data item range from presenting no indicator to presenting a home start time, a home end time, a home time zone indicator, a home time zone of the time sensitive scheduling data item, reception time zone start time, reception time zone end time, reception time zone indicator, reference time zone start time, reference time zone end time, and reference time zone indicator.

35. The system of claim 23, further comprising:
a processor for processing an executable instruction for adjusting reception time zone presentation to a time sensitive scheduling data delivery network user by presenting the time sensitive scheduling data item's time frame in accordance with the time sensitive scheduling data receiving device's profile and assigned preference.

36. The system of claim 35, wherein the time sensitive scheduling data receiving device's preference is assigned based on device capabilities.

37. The system of claim 35, wherein the time sensitive scheduling data receiving device's preference is assigned based on receiving entity preferences for the receiving device.

38. A computer program product executable by a computer processor for processing the presenting of time frame elements of passive delivery time sensitive scheduling data to an entity based on a reception time zone via a time sensitive scheduling data delivery network, comprising:
computer code for accommodating a communications network passive delivery of time zone adjusted time sensitive scheduling data to an entity; computer code for aggregating into time sensitive scheduling data streams, specific time zone adjusted time sensitive scheduling data from originating organizations, affiliated groups of individuals, and individuals;
computer code for transmitting via the communications network specific time zone adjusted time sensitive scheduling data streams aggregated from multiple originating organizations, affiliated groups of individuals, and individuals to the entity; computer code for presenting time sensitive scheduling data and notices of upcoming time sensitive scheduling data activities in a dynamically adjusted manner affording the time zone adjustment based on a reception time zone in which the time sensitive scheduling data is being presented; and
computer readable medium for storing the computer code.

39. The computer program product of claim 38, further comprising:
transforming home time frame elements of time sensitive scheduling data in a manner affording time frame identification in the reception time zone in which the time sensitive scheduling data item is being transmitted and presented.

40. The computer program product of claim 39, wherein transforming consists of exposing time zone indicators, and wherein exposing time zone indicators represents the amount of presentation necessary to communicate when an activity occurs in its home time zone relative to the reception time zone where the activity is being presented.

41. The computer program product of claim 39, wherein transforming occurs within a programming function at the sourcing data center for transmission and on capable time sensitive scheduling data receiving devices for presentation.

42. The computer program product of claim 38, further comprising:
establishing the reception time zone presentation state for transmission and presentation of time sensitive scheduling data according to a base time zone for displaying and playing the time sensitive scheduling data.

43. The computer program product of claim 38, further comprising:
establishing the reception time zone presentation state for transmission and presentation of time sensitive scheduling data according to a designated reception time zone for the time sensitive scheduling data.

44. The computer program product of claim 38, further comprising:
establishing the reception time zone presentation state for transmission and presentation of reminder time sensitive scheduling data according to a receiving entity's reception time zone presentation preference for time sensitive scheduling data, the closeness to start time for the reminder time sensitive scheduling data activity, and a device receiving the reminder time sensitive scheduling data.

45. The computer program product of claim 44, wherein the reminder time sensitive scheduling data is selected from the group consisting of receiving entity designated reminder items, receiving entity tagged reminder items, time sensitive scheduling data treated as observances, and a combination thereof.

46. The computer program product of claim 38, further comprising:
establishing the reception time zone presentation state for transmission and presentation of reservation time sensitive scheduling data according to a receiving entity's presentation reception time zone presentation preference for time sensitive scheduling data, the closeness to start time for the reservation time sensitive scheduling data activity, and a device receiving the reservation time sensitive scheduling data.

47. The computer program product of claim 46, wherein the reservation time sensitive scheduling data is selected from the group consisting of alerts, reminders, warnings, and time period count downs associated with appointments, pre-arranged blocks of time set aside to receive services for the group of services including transportation reservations, medical appointments, vehicle repair reservations, dinner reservations, and a combination thereof.

48. The computer program product of claim 39, wherein the time frame adjustment afforded is based on the representation of a time sensitive scheduling data item within a communication transmitted from the data center source data store to the receiving device.

49. The computer program product of claim 38, wherein the representation of the time zone indicators of a time sensitive scheduling data item range from presenting no indicator to presenting a home start time, a home end time, a home time zone indicator, a home time zone of the time sensitive scheduling data item, reception time zone start time, reception time zone end time, reception time zone indicator, reference time zone start time, reference time zone end time, and reference time zone indicator.

50. The computer program product of claim 38, further comprising: adjusting reception time zone presentation to a time sensitive scheduling data delivery network user by presenting the time sensitive scheduling data item's time frame in accordance with the time sensitive scheduling data receiving device's profile and assigned preference.

51. The computer program product of claim 50, wherein the time sensitive scheduling data receiving device's preference is assigned based on device capabilities.

52. The computer program product of claim 50, wherein the time sensitive scheduling data receiving device's preference is assigned based on receiving entity preferences for the receiving device.
